(19) United States
(12) Patent Application Publication
(10) Pub. No.: US 2018/0319943 A1
(43) Pub. Date: Nov. 8, 2018

(54) POROUS MEMBRANE AND MEMBRANE SUPPORT WITH INTEGRATED HIGH PERMEABILITY BARRIER

(71) Applicant: Lockheed Martin Corporation, Bethesda, MD (US)

(72) Inventors: Han Liu, Timonium, MD (US); Jacob Louis Swett, Pleasant Hill, MO (US); Michael J. Hiltabidle, Mount Laurel, NJ (US)

(21) Appl. No.: 15/589,135

(22) Filed: May 8, 2017

(51) Int. Cl. C08J 5/18; B05D 1/00; B05D 3/06; C09D 179/08; C09D 7/12; C08J 7/12

(52) U.S. Cl. CPC C08J 5/18; B05D 1/005; B05D 3/068; C08K 3/08; C09D 7/1291; C08J 7/123; C08J 2379/08; C09D 179/08

(57) ABSTRACT

A membrane can contain at least one substrate layer, wherein the substrate layer includes a plurality of substrate pores, and each of the substrate pores contains a plurality of nanotubes or nanowires positioned within the substrate pore. Such membranes can be incorporated into enclosures for various substances. The enclosures can be exposed to an environment, such as a biological environment (in vivo or in vitro), where the membrane can delay or not provoke an immune response from the environment. One or more substances within the enclosure can be released into the environment, one or more selected substances from the environment can enter the enclosure, one or more selected substances from the environment can be prevented from entering the enclosure, one or more selected substances can be retained within the enclosure, or combinations thereof. The enclosure can, for example, allow a sense-response paradigm to be realized.

### BACKGROUND

Polymeric devices and hydrogels as a delivery vehicle or enclosure including examples such as silicone, hydrogels, alginate, cellulose sulfate, collagen, gelatin, agarose, chitosan and the like, or polytetrafluoroethylene (e.g., expanded PTFE) with a backing of unwoven polyester mesh, often fail by biofouling, biocompatibility issues, and a lengthy diffusion time of substances into and out of the vehicle. Thickness of the device can limit efficacy, due in part to impeded transfer of substances into and out of the device. Low permeability, at least in part, due to thickness and mechanical stability in view of physical stress can also be problematic. Moreover, synthetic membranes or semi-permeable walls, especially when integrating those membranes in vitro or in vivo present barriers to replicating the semi-permeance that biological membranes provide. Such membranes insufficiently achieve immunoisolation.

Improved selective barriers operating under a variety of conditions, including in a biological environment, would be of considerable benefit in the art.

### SUMMARY

Some embodiments may include membranes that may comprise at least one substrate layer and at least one porous layer devoid of carbon nanotubes or carbon nanowires, wherein each substrate layer may comprise a plurality of substrate pores, and each of the substrate pores may comprise a plurality of carbon nanotubes or carbon nanowires positioned within the substrate pore; and each substrate layer and each porous layer may comprise a material independently selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof. In some embodiments, each substrate layer may have a thickness of about 1 mm or less. In some embodiments, each of the substrate pores in each substrate layer may have a diameter of about 500 μm or less. In some embodiments, each of the carbon nanotubes or carbon nanowires may have a diameter of about 150 nm or less. In some embodiments, carbon nanotubes or carbon nanowires may be dispersed within each substrate layer. In some further embodiments, the substrate layer may comprise 5 wt. % or less of the carbon nanotubes or carbon nanowires.

Some embodiments may comprise membranes that may comprise at least one substrate layer, wherein each substrate layer may comprise a plurality of substrate pores, where each of the substrate pores comprises a plurality of nanotubes or nanowires positioned within the substrate pore, and the substrate layer may comprise a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof. In some embodiments, each substrate layer may have a thickness of about 1 mm or less. In some embodiments, each of the substrate pores in each substrate layer may have a diameter of about 500 μm or less. In some embodiments, each of the nanotubes or nanowires may have a diameter of about 500 nm or less. In some embodiments, the nanotubes or nanowires may be dispersed within each substrate layer. In some further embodiments, at least one substrate layer may comprise 5 wt. % or less of the nanotubes or nanowires. In some embodiments, the membrane comprises two or more substrate layers and a weight percentage of nanotubes or nanowires is not the same for all of the substrate layers. In some embodiments, the nanotubes or nanowires are carbon nanotubes or carbon nanowires. In some embodiments, the nanotubes or nanowires comprise elemental metal. In some embodiments, the nanotubes or nanowires comprise gold, silver, platinum, palladium, chromium, copper, titanium, stainless steel, vanadium oxide, or any combination of two or more thereof. In some embodiments, the membrane comprises two or more substrate layers and the nanotubes or nanowires within each substrate layer do not comprise the same material.

Some embodiments may include membranes that may comprise a perforated graphene-based material layer and a substrate layer, wherein the substrate layer may comprise a plurality of substrate pores, and each of the substrate pores may comprise a plurality of nanotubes or nanowires positioned within the substrate pore. In some embodiments, the substrate layer may comprise a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof. In some embodiments, each substrate layer may have a thickness of about 1 mm or less. In some embodiments, each of the substrate pores in each substrate layer may have a diameter of about 500 μm or less. In some embodiments, each of the nanotubes or nanowires may have a diameter of about 500 nm or less. In some embodiments, the nanotubes or nanowires may be dispersed within each substrate layer. In some further embodiments, the substrate layer comprises 5 wt. % or less of the nanotubes or nanowires. In some embodiments, the nanotubes or nanowires are carbon nanotubes or carbon nanowires. In some embodiments, the nanotubes or nanowires comprise elemental metal. In some embodiments, the nanotubes or nanowires comprise gold, silver, platinum, palladium, chromium, copper, titanium, stainless steel, vanadium oxide, or any combination of two or more thereof. In some embodiments, the perforated graphene-based material layer may have pores with a diameter of from about 1 nm to about 100 nm. In some embodiments, the graphene-based material may be graphene. In some embodiments, the perforated graphene-based material layer may comprise at least one perforated graphene layer. In some embodiments, the membrane further comprises an intermediate layer positioned between the perforated graphene-based material layer and the substrate layer.

Some embodiments may comprise membranes that may comprise at least one substrate layer; at least one porous layer devoid of nanotubes or nanowires; and a barrier layer; wherein each substrate layer comprises a plurality of substrate pores, and each of the substrate pores may comprise a plurality of nanotubes or nanowires positioned within the substrate pore; and each substrate layer and each porous layer may comprise a material independently selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof. In some embodiments, each substrate layer may have a thickness of about 1 mm or less. In some embodiments, each of the substrate pores in each substrate layer may have a diameter of about 500 μm or less. In some embodiments, each of the nanotubes or nanowires may have a diameter of about 500 nm or less. In some embodiments, the nanotubes or nanowires may be dispersed within each substrate layer. In some further embodiments, at least one substrate layer may comprise 5 wt. % or less of the nanotubes or nanowires. In some embodiments, the membrane comprises two or more substrate layers and a weight percentage of nanotubes or nanowires is not the same for all of the substrate layers. In some embodiments, the membrane comprises two or more substrate layers and the nanotubes or nanowires within each substrate layer do not comprise the same material. In some embodiments, the nanotubes or nanowires are carbon nanotubes or carbon nanowires. In some embodiments, the nanotubes or nanowires comprise elemental metal. In some embodiments, the nanotubes or nanowires comprise gold, silver, platinum, palladium, chromium, copper, titanium, stainless steel, vanadium oxide, or any combination of two or more thereof. In some embodiments, the barrier layer may comprise a perforated graphene-based material layer. In some further embodiments, the perforated graphene-based material layer may have pores with a diameter of from about 1 nm to about 100 nm. In some embodiments, the graphene-based material may be graphene. In some further embodiments, the perforated graphene-based material layer may comprise at least one perforated graphene layer. In some embodiments, the membrane further comprises an intermediate layer positioned between the perforated graphene-based material layer and at least one substrate layer.

Some embodiments may comprise membranes that may comprise at least one substrate layer, wherein the substrate layer may comprise a plurality of substrate pores, and each of the substrate pores may comprise a plurality of nanotubes or nanowires positioned within the substrate pore. In some embodiments, each substrate layer may comprise a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof. In some embodiments, each substrate layer may have a thickness of about 1 mm or less. In some embodiments, each substrate layer may have a thickness of about 100 nm to about 1 mm. In some embodiments, each substrate layer may have a thickness of about 1 μm to about 25 μm. In some embodiments, each substrate layer may have a porosity gradient throughout its thickness. In some embodiments, each of the substrate pores may have a diameter of about 500 μm or less. In some embodiments, each of the substrate pores may have a diameter of about 30 nm to about 500 μm. In some embodiments, each of the substrate pores may have a diameter of about 500 nm to about 100 μm. In some embodiments, each of the nanotubes or nanowires may have a diameter of about 500 nm or less. In some embodiments, each of the nanotubes or nanowires may have a diameter of about 1 nm to about 500 nm. In some embodiments, each of the nanotubes or nanowires may have a diameter of about 5 nm to about 500 nm. In some embodiments, the nanotubes or nanowires may be dispersed within the substrate layer. In some further embodiments, at least one substrate layer may comprise 5 wt. % or less of the nanotubes or nanowires. In some embodiments, the membrane may comprise one substrate layer. In some embodiments, the membrane comprises two or more substrate layers and a weight percentage of nanotubes or nanowires is not the same for all of the substrate layers. In some embodiments, the membrane comprises two or more substrate layers and the nanotubes or nanowires within each substrate layer do not comprise the same material. In some embodiments, the nanotubes or nanowires are carbon nanotubes or carbon nanowires. In some embodiments, the nanotubes or nanowires comprise elemental metal. In some embodiments, the nanotubes or nanowires comprise gold, silver, platinum, palladium, chromium, copper, titanium, stainless steel, vanadium oxide, or any combination of two or more thereof. In some embodiments, the membrane may further comprise a barrier layer. In some embodiments, the barrier layer may comprise a perforated graphene-based material layer. In some embodiments, the perforated graphene-based material layer may have pores with a size sufficient to allow a pharmaceutical to pass through the pores. In some embodiments, the perforated graphene-based material layer may have pores with a diameter of from about 1 nm to about 100 nm. In some embodiments, the graphene-based material may be graphene. In some embodiments, the perforated graphene-based material layer may comprise at least one perforated graphene layer. In some embodiments, the membrane may further comprise at least one porous layer devoid of nanotubes or nanowires. In some embodiments, the membrane may comprise alternating layers of the substrate layer and of the porous layer devoid of nanotubes or nanowires. In some embodiments, the barrier layer may be positioned as an outermost layer of the membrane. In some embodiments, one substrate layer may be directly disposed on the barrier layer. In some embodiments, one substrate layer may be indirectly disposed on the barrier layer. In some embodiments, the membrane further comprises an intermediate layer positioned between the perforated graphene-based material layer and one substrate layer.

In some embodiments, the membrane may be configured into enclosures or encapsulation devices that may comprise a compartment and a wall separating the compartment from an environment external to the compartment, wherein the wall may comprise a membrane. Such enclosures can be in any shape or size including cylinders, flat sheets, disks, etc. such as referenced in, for example, U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially for their description relating to shapes and sizes of encapsulation devices. In some embodiments, the enclosure may further comprise at least one substance within the compartment such as sensors, pharmaceuticals, etc. In some embodiments, two or more substances may be encapsulated or enclosed. In some embodiments, the substrate pores of the substrate layer may be of a size sufficient to retain the one or more substances within the compartment and to exclude other environmental substances such as for example referred to in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially for their description of encapsulation techniques and biological environmental parameters, including immune cells and immune complexes in the environment external to the compartment, such substances being prevented from entering the compartment (a materially significant level.). In some embodiments, the enclosure may delay or not provoke an immune response from the environment. In some embodiments, the enclosure may delay or not provoke an immune response from a subject when the enclosure is in use within the subject.

Some embodiments may comprise coated therapeutic devices that may comprise a therapeutic device and a coating on the therapeutic device, wherein the coating may comprise a membrane. In some embodiments, the coated therapeutic device may delay or prevent an immune response from a biological environment. In some embodiments, the coated therapeutic device may delay or not provoke an immune response from a biological environment.

Some embodiments may comprise methods of releasing a substance that may comprise exposing an enclosure comprising a wall comprising a membrane to an environment, to thereby release into the environment at least one substance from a compartment in the enclosure, wherein the enclosure may delay or not provoke an immune response from the environment. In some embodiments, the environment may be a biological environment. In some embodiments, the substance may be a pharmaceutical.

Some embodiments may comprise methods comprising exposing an enclosure comprising a membrane to an environment, to thereby release at least one first substance into the environment and to allow passage of a second substance from the environment into the enclosure, wherein the membrane may delays or not provoke an immune response from the environment.

Some embodiments may comprise methods of delaying or preventing an immune response from an environment due to the presence of a device comprising encapsulating the device with a membrane.

### BRIEF DESCRIPTION OF THE DRAWINGS

FIGS. 1A and 1B are schematic illustrations of some embodiments of an enclosure implemented for immunoisolation of substances.

FIGS. 2A-2E show illustrative schematics of some embodiments with various configurations of enclosure configurations comprising one or more walls comprising a membrane.

FIG. 3A illustrates some non-limiting embodiments of a membrane comprising a perforated graphene-based material layer (52) and a substrate layer (51), wherein the substrate layer comprises a plurality of substrate pores (53), and each of the substrate pores comprises a plurality of nanotubes or nanowires (54) positioned within the substrate pore. For the sake of clarity, nanotubes or nanowires are only shown in one substrate pore.

FIG. 3B illustrates some non-limiting embodiments of a membrane comprising a substrate layer (62), shown without the nanotubes or nanowires positioned in the substrate pore, between two porous layers devoid of nanotubes or nanowires (62 and 63).

FIGS. 4A-4C illustrate some embodiments for preparing an enclosure.

FIG. 5 illustrates a micrograph obtained by digital optical microscope of a non-limiting embodiment of a substrate layer comprising polyimide and silver nanowires.

FIG. 6 illustrates a micrograph obtained by scanning electron microscope of a non-limiting embodiment of a substrate layer comprising polyimide and silver nanowires.

### DETAILED DESCRIPTION

In one aspect, provided herein are some embodiments with membranes comprising at least one substrate layer, wherein each substrate layer comprises a plurality of substrate pores, and each of the substrate pores comprises a plurality of nanotubes or nanowires positioned within the substrate pore. Some embodiments may comprise membranes comprising at least one substrate layer, wherein each substrate layer comprises a plurality of substrate pores, and each of the substrate pores comprises a plurality of carbon nanotubes or carbon nanowires positioned within the substrate pore.

Some embodiments may comprise membranes comprising at least one substrate layer and at least one porous layer devoid of nanotubes or nanowires, wherein each substrate layer comprises a plurality of substrate pores, and each of the substrate pores comprises a plurality of nanotubes or nanowires positioned within the substrate pore. In some embodiments, the membrane consists essentially of or consists of at least one substrate layer and at least one porous layer devoid of nanotubes or nanowires, wherein each substrate layer comprises a plurality of substrate pores, and each of the substrate pores comprises a plurality of nanotubes or nanowires positioned within the substrate pore.

Some embodiments may comprise membranes comprising at least one substrate layer; at least one porous layer devoid of nanotubes or nanowires; and a barrier layer; wherein each substrate layer comprises a plurality of substrate pores, and each of the substrate pores comprises a plurality of nanotubes or nanowires positioned within the substrate pore. In some embodiments, the membrane consists essentially of or consists of at least one substrate layer; at least one porous layer devoid of nanotubes or nanowires; and a barrier layer; wherein each substrate layer comprises a plurality of substrate pores, and each of the substrate pores comprises a plurality of nanotubes or nanowires positioned within the substrate pore.

Some embodiments may comprise membranes comprising a perforated graphene-based material layer and a substrate layer, wherein the substrate layer comprises a plurality of substrate pores, and each of the substrate pores comprises a plurality of nanotubes or nanowires positioned within the substrate pore. In some embodiments, the membrane consists essentially of or consists of a perforated graphene-based material layer and a substrate layer, wherein the substrate layer comprises a plurality of substrate pores, and each of the substrate pores comprises a plurality of nanotubes or nanowires positioned within the substrate pore.

Some embodiments may comprise membranes comprising at least one substrate layer; at least one porous layer devoid of nanotubes or nanowires; and a perforated graphene-based material layer; wherein each substrate layer comprises a plurality of substrate pores, and each of the substrate pores comprises a plurality of nanotubes or nanowires positioned within the substrate pore. In some embodiments, the membrane consists essentially of or consists of at least one substrate layer; at least one porous layer devoid of nanotubes or nanowires; and a perforated graphene-based material layer; wherein each substrate layer comprises a plurality of substrate pores, and each of the substrate pores comprises a plurality of nanotubes or nanowires positioned within the substrate pore. In some further embodiments, at least one porous layer devoid of nanotubes or nanowires is positioned between the substrate layer and the perforated graphene-based material layer.

Some embodiments may comprise membranes comprising a perforated graphene-based material layer and a substrate layer, wherein the substrate layer comprises a plurality of substrate pores, and each of the substrate pores comprises a plurality of nanotubes or nanowires positioned within the substrate pore. In some embodiments, the membrane consists essentially of or consists of a perforated graphene-based material layer and a substrate layer, wherein the substrate layer comprises a plurality of substrate pores, and each of the substrate pores comprises a plurality of nanotubes or nanowires positioned within the substrate pore.

Some embodiments may comprise membranes comprising at least one substrate layer; at least one porous layer devoid of nanotubes or nanowires; an intermediate layer; and a perforated graphene-based material layer; wherein each substrate layer comprises a plurality of substrate pores, and each of the substrate pores comprises a plurality of nanotubes or nanowires positioned within the substrate pore. In some embodiments, the membrane consists essentially of or consists of at least one substrate layer; at least one porous layer devoid of nanotubes or nanowires; an intermediate layer; and a perforated graphene-based material layer; wherein each substrate layer comprises a plurality of substrate pores, and each of the substrate pores comprises a plurality of nanotubes or nanowires positioned within the substrate pore. In some further embodiments, at least one porous layer devoid of nanotubes or nanowires is positioned between the substrate layer and the perforated graphene-based material layer. In some embodiments, the intermediate layer is positioned between one substrate layer and the perforated graphene-based material layer. In some embodiments, the intermediate layer is positioned between one porous layer devoid of nanotubes or nanowires and the perforated graphene-based material layer.

Some embodiments may comprise membranes comprising at least one substrate layer and at least one porous layer devoid of carbon nanotubes or carbon nanowires, wherein each substrate layer comprises a plurality of substrate pores, and each of the substrate pores comprises a plurality of carbon nanotubes or carbon nanowires positioned within the substrate pore. In some embodiments, the membrane consists essentially of or consists of at least one substrate layer and at least one porous layer devoid of carbon nanotubes or carbon nanowires, wherein each substrate layer comprises a plurality of substrate pores, and each of the substrate pores comprises a plurality of carbon nanotubes or carbon nanowires positioned within the substrate pore.

Some embodiments may comprise membranes comprising at least one substrate layer; at least one porous layer devoid of carbon nanotubes or carbon nanowires; and a barrier layer; wherein each substrate layer comprises a plurality of substrate pores, and each of the substrate pores comprises a plurality of carbon nanotubes or carbon nanowires positioned within the substrate pore. In some embodiments, the membrane consists essentially of or consists of at least one substrate layer; at least one porous layer devoid of carbon nanotubes or carbon nanowires; and a barrier layer; wherein each substrate layer comprises a plurality of substrate pores, and each of the substrate pores comprises a plurality of carbon nanotubes or carbon nanowires positioned within the substrate pore.

Some embodiments may comprise membranes comprising a perforated graphene-based material layer and a substrate layer, wherein the substrate layer comprises a plurality of substrate pores, and each of the substrate pores comprises a plurality of carbon nanotubes or carbon nanowires positioned within the substrate pore. In some embodiments, the membrane consists essentially of or consists of a perforated graphene-based material layer and a substrate layer, wherein the substrate layer comprises a plurality of substrate pores, and each of the substrate pores comprises a plurality of carbon nanotubes or carbon nanowires positioned within the substrate pore.

Some embodiments may comprise membranes comprising at least one substrate layer; at least one porous layer devoid of carbon nanotubes or carbon nanowires; and a perforated graphene-based material layer; wherein each substrate layer comprises a plurality of substrate pores, and each of the substrate pores comprises a plurality of carbon nanotubes or carbon nanowires positioned within the substrate pore. In some embodiments, the membrane consists essentially of or consists of at least one substrate layer; at least one porous layer devoid of carbon nanotubes or carbon nanowires; and a perforated graphene-based material layer; wherein each substrate layer comprises a plurality of substrate pores, and each of the substrate pores comprises a plurality of carbon nanotubes or carbon nanowires positioned within the substrate pore. In some further embodiments, at least one porous layer devoid of carbon nanotubes or carbon nanowires is positioned between the substrate layer and the perforated graphene-based material layer.

Some embodiments may comprise membranes comprising at least one substrate layer; at least one porous layer devoid of carbon nanotubes or carbon nanowires; an intermediate layer; and a perforated graphene-based material layer; wherein each substrate layer comprises a plurality of substrate pores, and each of the substrate pores comprises a plurality of carbon nanotubes or carbon nanowires positioned within the substrate pore. In some embodiments, the membrane consists essentially of or consists of at least one substrate layer; at least one porous layer devoid of carbon nanotubes or carbon nanowires; and a perforated graphene-based material layer; wherein each substrate layer comprises a plurality of substrate pores, and each of the substrate pores comprises a plurality of carbon nanotubes or carbon nanowires positioned within the substrate pore. In some further embodiments, at least one porous layer devoid of carbon nanotubes or carbon nanowires is positioned between the substrate layer and the perforated graphene-based material layer. In some embodiments, the intermediate layer is positioned between one substrate layer and the perforated graphene-based material layer. In some embodiments, the intermediate layer is positioned between one porous layer devoid of nanotubes or nanowires and the perforated graphene-based material layer.

Some embodiments may comprise membranes comprising at least one substrate layer and at least one porous layer devoid of nanotubes or nanowires, wherein each substrate layer comprises a plurality of substrate pores, and each of the substrate pores comprises a plurality of silver nanotubes or silver nanowires positioned within the substrate pore. In some embodiments, the membrane consists essentially of or consists of at least one substrate layer and at least one porous layer devoid of nanotubes or nanowires, wherein each substrate layer comprises a plurality of substrate pores, and each of the substrate pores comprises a plurality of silver nanotubes or silver nanowires positioned within the substrate pore.

Some embodiments may comprise membranes comprising at least one substrate layer; at least one porous layer devoid of nanotubes or nanowires; and a barrier layer; wherein each substrate layer comprises a plurality of substrate pores, and each of the substrate pores comprises a plurality of silver nanotubes or silver nanowires positioned within the substrate pore. In some embodiments, the membrane consists essentially of or consists of at least one substrate layer; at least one porous layer devoid of nanotubes or nanowires; and a barrier layer; wherein each substrate layer comprises a plurality of substrate pores, and each of the substrate pores comprises a plurality of silver nanotubes or silver nanowires positioned within the substrate pore.

Some embodiments may comprise membranes comprising a perforated graphene-based material layer and a substrate layer, wherein the substrate layer comprises a plurality of substrate pores, and each of the substrate pores comprises a plurality of silver nanotubes or silver nanowires positioned within the substrate pore. In some embodiments, the membrane consists essentially of or consists of a perforated graphene-based material layer and a substrate layer, wherein the substrate layer comprises a plurality of substrate pores, and each of the substrate pores comprises a plurality of silver nanotubes or silver nanowires positioned within the substrate pore.

Some embodiments may comprise membranes comprising at least one substrate layer; at least one porous layer devoid of nanotubes or nanowires; and a perforated graphene-based material layer; wherein each substrate layer comprises a plurality of substrate pores, and each of the substrate pores comprises a plurality of silver nanotubes or silver nanowires positioned within the substrate pore. In some embodiments, the membrane consists essentially of or consists of at least one substrate layer; at least one porous layer devoid of nanotubes or nanowires; and a perforated graphene-based material layer; wherein each substrate layer comprises a plurality of substrate pores, and each of the substrate pores comprises a plurality of silver nanotubes or silver nanowires positioned within the substrate pore. In some further embodiments, at least one porous layer devoid of nanotubes or nanowires is positioned between the substrate layer and the perforated graphene-based material layer.

Some embodiments may comprise membranes comprising at least one substrate layer; at least one porous layer devoid of nanotubes or nanowires; an intermediate layer; and a perforated graphene-based material layer; wherein each substrate layer comprises a plurality of substrate pores, and each of the substrate pores comprises a plurality of silver nanotubes or silver nanowires positioned within the substrate pore. In some embodiments, the membrane consists essentially of or consists of at least one substrate layer; at least one porous layer devoid of nanotubes or nanowires; and a perforated graphene-based material layer; wherein each substrate layer comprises a plurality of substrate pores, and each of the substrate pores comprises a plurality of silver nanotubes or silver nanowires positioned within the substrate pore. In some further embodiments, at least one porous layer devoid of nanotubes or nanowires is positioned between the substrate layer and the perforated graphene-based material layer. In some embodiments, the intermediate layer is positioned between one substrate layer and the perforated graphene-based material layer. In some embodiments, the intermediate layer is positioned between one porous layer devoid of nanotubes or nanowires and the perforated graphene-based material layer.

In another aspect, provided herein are some embodiments with enclosures comprising a compartment and a wall separating the compartment from an environment external to the compartment, wherein the wall comprises a membrane. In some embodiments, the membrane comprises at least one substrate layer, wherein the substrate layer comprises a plurality of substrate pores, and each of the substrate pores comprises a plurality of carbon nanotubes or carbon nanowires positioned within the substrate pore. In some embodiments, the membrane comprises at least one substrate layer and at least one porous layer devoid of carbon nanotubes or carbon nanowires, wherein each substrate layer comprises a plurality of substrate pores, and each of the substrate pores comprises a plurality of carbon nanotubes or carbon nanowires positioned within the substrate pore. In some embodiments, the membrane comprises at least one substrate layer; at least one porous layer devoid of carbon nanotubes or carbon nanowires; and a barrier layer; wherein each substrate layer comprises a plurality of substrate pores, and each of the substrate pores comprises a plurality of carbon nanotubes or carbon nanowires positioned within the substrate pore. In some embodiments, the membrane comprises a perforated graphene-based material layer and a substrate layer, wherein the substrate layer comprises a plurality of substrate pores, and each of the substrate pores comprises a plurality of carbon nanotubes or carbon nanowires positioned within the substrate pore. In some embodiments, the membrane comprises at least one substrate layer; at least one porous layer devoid of carbon nanotubes or carbon nanowires; and a perforated graphene-based material layer; wherein each substrate layer comprises a plurality of substrate pores, and each of the substrate pores comprises a plurality of carbon nanotubes or carbon nanowires positioned within the substrate pore.

In another aspect, provided herein are some embodiments with coated therapeutic devices comprising a therapeutic device and a coating on the therapeutic device, wherein the coating comprises a membrane. In some embodiments, the membrane comprises at least one substrate layer, wherein the substrate layer comprises a plurality of substrate pores, and each of the substrate pores comprises a plurality of carbon nanotubes or carbon nanowires positioned within the substrate pore. In some embodiments, the membrane comprises at least one substrate layer and at least one porous layer devoid of carbon nanotubes or carbon nanowires, wherein each substrate layer comprises a plurality of substrate pores, and each of the substrate pores comprises a plurality of carbon nanotubes or carbon nanowires positioned within the substrate pore. In some embodiments, the membrane comprises at least one substrate layer; at least one porous layer devoid of carbon nanotubes or carbon nanowires; and a barrier layer; wherein each substrate layer comprises a plurality of substrate pores, and each of the substrate pores comprises a plurality of carbon nanotubes or carbon nanowires positioned within the substrate pore. In some embodiments, the membrane comprises a perforated graphene-based material layer and a substrate layer, wherein the substrate layer comprises a plurality of substrate pores, and each of the substrate pores comprises a plurality of carbon nanotubes or carbon nanowires positioned within the substrate pore. In some embodiments, the membrane comprises at least one substrate layer; at least one porous layer devoid of carbon nanotubes or carbon nanowires; and a perforated graphene-based material layer; wherein each substrate layer comprises a plurality of substrate pores, and each of the substrate pores comprises a plurality of carbon nanotubes or carbon nanowires positioned within the substrate pore.

Membranes

Some of the membranes described herein may comprise at least one substrate layer, wherein each substrate layer comprises a plurality of substrate pores, and each of the substrate pores comprises a plurality of nanotubes or nanowires positioned within the substrate pore. In some embodiments, the membranes may comprise at least one substrate layer, wherein each substrate layer comprises a plurality of substrate pores, and each of the substrate pores comprises a plurality of carbon nanotubes or carbon nanowires positioned within the substrate pore.

The substrate layer may comprise a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof. In some embodiments, the substrate layer may comprise polyimide, polycarbonate, PET, expanded PTFE, or any combination of two or more thereof. Expanded PTFE includes multi-directionally expanded PTFE and uni-directionally expanded PTFE. In some embodiments, the substrate layer may comprise polyimide. In some embodiments, materials used to make the substrate layer are highly pure, contain no solvents, and/or are of a medical grade. In some embodiments, the materials are biocompatible, bioinert and/or medical grade materials.

In some embodiments, the substrate layer has a thickness of about 1 mm or less, about 0.5 mm or less, about 1 μm or less, or about 100 nm or less. In some embodiments, a thickness of the substrate layer can range from about 100 nm to about 1 mm, or about 100 nm to about 100 μm, or about 1 μm to about 50 μm, or about 1 μm to about 25 μm, or about 5 μm to about 25 μm, or about 20 μm to about 30 μm, or about 3 μm to about 25 μm. In some embodiments, the substrate layer has a thickness about 1 μm or greater, about 3 μm or greater, about 5 μm or greater, about 10 μm or greater, about 15 μm or greater, or 20 μm or greater. In some embodiments, the substrate layer has a thickness of less than 1 μm. In some embodiments, the substrate layer has a thickness of about 10 nm to about 100 nm, or about 20 nm to about 50 nm. In some embodiments, the substrate layer has a thickness of about 100, 200, 300, 400, 500, 600, 700, 800, or 900 nm, including increments therein. In some embodiments, the substrate layer has a thickness of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 200, 300, 400, 500, 600, 700, 800, 900, or 1000 μm, including increments therein.

In some embodiments, the substrate layer can have a porosity gradient throughout its thickness, which can be measured for instance using imagery. Porosity gradient includes a change, along a dimension of the substrate layer, in the porosity or total pore volume as a function of distance from one face of the substrate layer. For example, throughout the thickness of the substrate layer, the porosity can change in a regular or irregular manner. A porosity gradient can decrease from one face of the substrate layer to the other. For example, the lowest porosity in the substrate layer can be located spatially closest to an optional barrier layer, and the highest porosity can be located farther away (e.g., spatially closer to an external environment). In some embodiments, a substrate layer can have a relatively low porosity close to the optional barrier layer, a higher porosity at a mid-point of the substrate layer thickness, and return to a relatively low porosity at an external surface distal to the optional barrier layer.

In some embodiments, the substrate layer can have a permeability gradient throughout its thickness. Permeability gradient, includes a change, along a dimension of the substrate layer, in the permeability or rate of flow of a liquid or gas through a porous material. For example, throughout the thickness of the substrate layer, the permeability can change in a regular or irregular manner. A permeability gradient can decrease from one face of the substrate layer to the other. For example, the lowest permeability in the substrate layer can be located spatially closest to the optional barrier layer (e.g., graphene or graphene-based film or other two-dimensional material), and the highest permeability can be located farther away. Those of skill in the art will understand that permeability of a layer can increase or decrease without pore diameter or porosity changing, e.g., in response to chemical functionalization, applied pressure, tortuosity, voltage, or other factors.

In some embodiments, the substrate pores may have a diameter of about 500 μm or less, or about 400 μm or less, or about 300 μm or less, or about 200 μm or less, or about 100 μm, or less, 50 μm or less. In some embodiments, the substrate pores may have a diameter of from about 1 nm to about 100 μm, or about 10 nm to about 1 μm, or about 20 nm to about 1 μm, or about 30 nm to about 1 μm, or about 40 nm to about 1 μm, or about 50 nm to about 1 μm, or about 10 nm to about 500 nm, or about 30 nm to about 100 nm, or about 100 nm to about 200 nm, or about 50 nm to about 120 nm, or about 500 nm to about 500 μm, or about 1 μm to about 5 μm, or about 1 μm to about 6 μm, or about 5 μm to about 10 μm. In some embodiments, the substrate pores may have a diameter of from about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 200, 300, 400, 500, 600, 700, 800, 900, or 1000 nm, including increments therein. In some embodiments, the substrate pores may have a diameter of from about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 200, 300, 400, or 500 μm, including increments therein. Substrate pore diameters in the substrate layer can be measured via porometry methods (e.g., capillary flow porometry). Substrate pore diameters in graphene can be extrapolated via imagery as described for example in US Patent Publication No. 2007-0036911 entitled “Perforated Sheets of Graphene-Based Material” which is incorporated herein in its entirety.

In some embodiments, the substrate layer can have an average pore size gradient throughout its thickness. Pore size gradient includes a layer with a plurality of pores, where the average diameter of the pores increases or decreases based on the proximity of the pore to a face of the substrate layer. For example, a substrate layer can have an average pore size gradient that decreases nearer the surface of an optional barrier layer. In some embodiments, an average pore size of the substrate layer is smaller nearer the surface of the optional barrier layer than at an opposite surface of the substrate layer.

In some embodiments, the pores of the substrate layer are cylindrically shaped within the substrate layer. In some embodiments, the pores of the substrate layer are asymmetrical shaped (such as, but not limited to, a conical shape) within the substrate layer. In some embodiments, the pores of the substrate layer have circularly shaped openings. In some embodiments, the pores of the substrate layer have asymmetrically shaped openings. In some embodiments, the pores of the substrate layer have elliptically shaped openings. In some embodiments, the pores of the substrate layer having openings shaped like long slits.

The nanotubes or nanowires include, but are not limited to, carbon nanotubes, carbon nanowires, inorganic nanotubes, inorganic nanowires, nanofibers, and any combination of two or more thereof. Carbon nanotubes and carbon nanowires include, but are not limited to, single walled carbon nanotubes, multiwalled carbon nanotubes, chiral nanotubes, and any combination of two or more thereof. Non-limiting examples of inorganic nanotubes or inorganic nanowires include metal oxide nanowires. In some embodiments, the nanotubes or nanowires are tungsten disulfide nanotubes. In some embodiments, the nanotubes or nanowires are carbon nanotubes or carbon nanowires. In some embodiments, the nanotubes or nanowires may be functionalized. In some embodiments, the nanotubes or nanowires may be coated. In some embodiments, the nanotubes or nanowires comprise elemental metal. In some embodiments, the nanotubes or nanowires comprise gold, silver, platinum, palladium, chromium, copper, titanium, stainless steel, vanadium oxide, or any combination of two or more thereof. In some embodiments, the nanotubes or nanowires comprise silver.

Each of the substrate pores in the substrate layer can comprise a plurality of nanotubes or nanowires positioned within the substrate pore. Each of the nanotubes or nanowires has a diameter of about 150 nm or less, 130 nm or less, 110 nm or less, or about 90 nm or less, or about 80 nm or less, or about 70 nm or less, or about 60 nm or less, or about 50 nm or less, or about 40 nm or less, or about 30 nm or less, or about 20 nm or less, or about 10 nm or less. In some embodiments, each of the nanotubes or nanowires has a diameter of about 1 nm to about 150 nm, about 1 nm to about 140 nm, about 1 nm to about 130 nm, about 1 nm to about 120 nm, about 1 nm to about 110 nm, about 1 nm to about 100 nm, or about 1 nm to about 90 nm, or about 1 nm to about 80 nm, or about 1 nm to about 70 nm, or about 1 nm to about 60 nm, or about 1 nm to about 50 nm, or about 1 nm to about 40 nm, or about 1 nm to about 30 nm, or about 1 nm to about 20 nm, or about 5 nm to about 100 nm, or about 5 nm to about 80 nm, or about 5 nm to about 50 nm, or about 20 nm to about 100 nm, or about 20 nm to about 80 nm, or about 20 nm to about 500 nm, or about 50 nm to about 100 nm, or about 50 nm to about 80 nm. In some embodiments, each of the nanotubes or nanowires has a diameter of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 nm, including increments therein.

Each of the substrate pores in the substrate layer can comprise a plurality of carbon nanotubes or carbon nanowires positioned within the substrate pore. Each of the carbon nanotubes or carbon nanowires has a diameter of about 150 nm or less, about 130 nm or less, about 110 nm or less, or about 90 nm or less, or about 80 nm or less, or about 70 nm or less, or about 60 nm or less, or about 50 nm or less, or about 40 nm or less, or about 30 nm or less, or about 20 nm or less, or about 10 nm or less. In some embodiments, each of the carbon nanotubes or carbon nanowires has a diameter of about 1 nm to about 150 nm, about 1 nm to about 140 nm, about 1 nm to about 130 nm, about 1 nm to about 120 nm, about 1 nm to about 110 nm, about 1 nm to about 100 nm, or about 1 nm to about 90 nm, or about 1 nm to about 80 nm, or about 1 nm to about 70 nm, or about 1 nm to about 60 nm, or about 1 nm to about 50 nm, or about 1 nm to about 40 nm, or about 1 nm to about 30 nm, or about 1 nm to about 20 nm, or about 5 nm to about 100 nm, or about 5 nm to about 80 nm, or about 5 nm to about 50 nm, or about 20 nm to about 100 nm, or about 20 nm to about 80 nm, or about 20 nm to about 500 nm, or about 50 nm to about 100 nm, or about 50 nm to about 80 nm. In some embodiments, each of the carbon nanotubes or carbon nanowires has a diameter of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 nm, including increments therein.

In some embodiments, the nanotubes or nanowires may comprise bundles of carbon nanotubes. A bundle of carbon nanotubes comprises two or more carbon nanotubes. A bundle of carbon nanotubes has a diameter of about 100 μm or less, or about 90 μm or less, or about 80 μm or less, or about 70 μm or less, or about 60 μm or less, or about 50 μm or less, or about 40 μm or less, or about 30 μm or less, or about 20 μm or less, or about 10 μm or less, or about 5 μm or less, or about 1 μm or less, or about 900 nm or less, or about 800 nm or less, or about 700 nm or less, or about 600 nm or less, or about 500 nm or less, or about 400 nm or less, or about 300 nm or less, or about 200 nm or less. In some embodiments, a bundle of carbon nanotubes has a diameter of about 1 μm to about 100 μm, or about 10 μm to about 100 μm, or about 25 μm to about 100 μm, or about 50 μm to about 100 μm, or about 75 μm to about 100 μm, or about 1 μm to about 75 μm, or about 1 μm to about 50 μm, or about 1 μm to about 25 μm, or about 200 nm to about 100 μm, or about 200 nm to about 50 μm, or about 200 nm to about 25 μm, or about 200 nm to about 10 μm, or about 200 nm to about 1 μm, or about 200 nm to about 750 nm, or about 200 nm to about 500 nm. In some embodiments, a bundle of carbon nanotubes has a diameter of about 100, 200, 300, 400, 500, 600, 700, 800, 900, 1000 nm, including increments therein. In some embodiments, a bundle of carbon nanotubes has a diameter of about 5, 10, 15, 20, 25, 30, 35, 40, 45, 50, 55, 60, 65, 70, 75, 80, 85, 90, 95, or 100 μm, including increments therein.

In some embodiments, the nanotubes or nanowires are dispersed within the substrate layer. In some embodiments, the substrate layer comprises about 5 wt. % or less, or about 4 wt. % or less, or about 3 wt. % or less, or about 2 wt. % or less, or about 1 wt. % or less of the nanotubes or nanowires. In some embodiments, the substrate layer comprises about 5 vol. % or less, or about 4 vol. % or less, or about 3 vol. % or less, or about 2 vol. % or less, or about 1 vol. % or less of the nanotubes or nanowires.

In some embodiments, the carbon nanotubes or carbon nanowires are dispersed within the substrate layer. In some embodiments, the substrate layer comprises about 5 wt. % or less, or about 4 wt. % or less, or about 3 wt. % or less, or about 2 wt. % or less, or about 1 wt. % or less of the carbon nanotubes or carbon nanowires. In some embodiments, the substrate layer comprises about 5 vol. % or less, or about 4 vol. % or less, or about 3 vol. % or less, or about 2 vol. % or less, or about 1 vol. % or less of the carbon nanotubes or carbon nanowires.

The nanotubes or nanowires may be positioned within the substrate pore in any orientation within the x/y planes. In some embodiments, the nanotubes or nanowires may be aligned with respect to one another within the substrate pore. In some embodiments, at least 10% of the nanotubes or nanowires may be aligned with respect to one another within the substrate pore. This includes at least 15, 20, 25, 30, 35, 40, 45, 50, 55, 60, 65, 70, 75, 80, 85, 90, or 95%, including increments therein, of the nanotubes or nanowires may be aligned with respect to one another within the substrate pore. In some embodiments, about 15, 20, 25, 30, 35, 40, 45, 50, 55, 60, 65, 70, 75, 80, 85, 90, or 95%, including increments therein, of the nanotubes or nanowires may be aligned with respect to one another within the substrate pore.

In some embodiments, the pores of the substrate layer may further comprise an infusion of porous polymer (such as, but not limited to, a hydrogel). The porous polymer may enhance the selective permeability of the pores of the substrate layer, allowing for small-molecule diffusion while blocking larger substance diffusion. One non-limiting example of hydrogel is alginate.

The inclusion of the nanotubes or nanowires into the substrate layer may impact the stiffness, Young's modulus, durability, elasticity, flexibility, or any combination of these properties of the substrate layer relative to a substrate layer devoid of nanotubes or nanowires. In some embodiments, these properties may influence the biocompatibility of the substrate layer and/or the device for which the substrate layer is a component. In some embodiments, these properties may influence the conductivity of the substrate layer and/or the device for which the substrate layer is a component. The density and/or diameter of nanotubes or nanowires in the substrate layer may influence the above-mentioned properties.

In some embodiments, the substrate layer may be further functionalized. In some embodiments, the substrate layer may be further functionalized with biomolecules (such as, but not limited to, proteins). In some embodiments, the substrate layer may be further functionalized with hydrophilic groups. In some embodiments, the substrate layer may be further functionalized with pegylation. In some embodiments, the substrate layer may be further functionalized by oxygen plasma treatment.

In some embodiments, at least one side of the substrate layer may have nanotubes or nanowires protruding from the surface. The protruding nanotubes or nanowires may interlock with a layer (such as, but not limited to, an intermediate layer or a porous layer devoid of nanotubes or nanowires) placed in contact with the substrate layer.

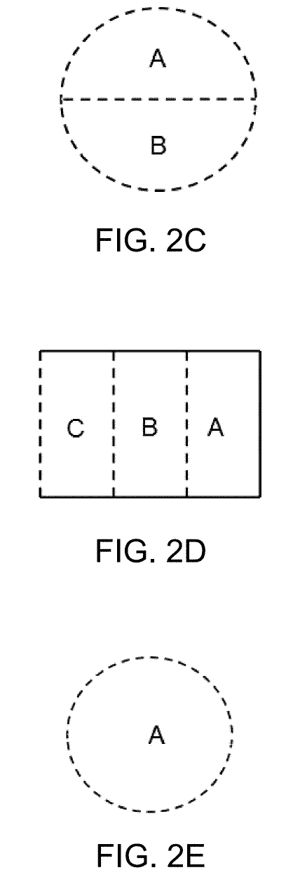

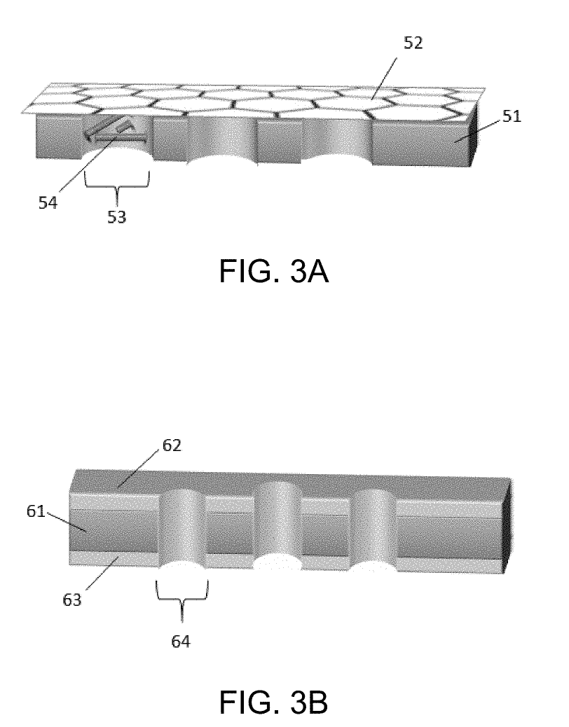

In some embodiments, the membrane may further comprise at least one porous layer devoid of nanotubes or nanowires. In some embodiments, the membrane may further comprise at least one porous layer devoid of carbon nanotubes or carbon nanowires. The at least one porous layer may comprise a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof. In some embodiments, the porous layer devoid of nanotubes or nanowires may comprise polyimide. In some embodiments, materials used to make the porous layer devoid of nanotubes or nanowires are highly pure, contain no solvents, and/or are of a medical grade. In some embodiments, the materials are biocompatible, bioinert and/or medical grade materials. FIG. 3B illustrates a non-limiting example of a membrane with a substrate layer (61) between two porous layers (62 and 63). In this figure, for the sake of clarity, the nanotubes or nanowires that are positioned in the substrate pores (64) of the substrate layer are not shown.

In some embodiments, the at least one porous layer and the at least one substrate layer may comprise the same polymeric materials. In some embodiments, the at least one porous layer and the at least one substrate layer may comprise different polymeric materials.

In some embodiments, the membrane comprises alternating layers of the substrate layer and of the porous layer devoid of nanotubes or nanowires. In some embodiments, the membrane may comprise one substrate layer in between two porous layers devoid of nanotubes or nanowires. In some embodiments, the membrane may comprise more substrate layers than porous layers devoid of nanotubes or nanowires. In some embodiments, the membrane may comprise more porous layers devoid of nanotubes or nanowires than substrate layers. In some embodiments, the porous layer devoid of nanotubes or nanowires may be an internal layer of the membrane. In some embodiments, the porous layer devoid of nanotubes or nanowires may be an external layer of the membrane.

In some embodiments, the membrane comprises alternating layers of the substrate layer and of the porous layer devoid of carbon nanotubes or carbon nanowires. In some embodiments, the membrane may comprise one substrate layer in between two porous layers devoid of carbon nanotubes or carbon nanowires. In some embodiments, the membrane may comprise more substrate layers than porous layers devoid of carbon nanotubes or carbon nanowires. In some embodiments, the membrane may comprise more porous layers devoid of carbon nanotubes or carbon nanowires than substrate layers.

In some embodiments, the porous layer devoid of nanotubes or nanowires provides structural support for the substrate layer.

In some embodiments, the membrane may further comprise a barrier layer. In some embodiments, the barrier layer may comprise a perforated graphene-based material layer. In some embodiments, the barrier layer may be a two-dimensional material layer. In some embodiments, the barrier layer may be a perforated two-dimensional material layer. FIG. 3A illustrates a non-limiting example of a membrane with a substrate layer (51) and a perforated two-dimensional material layer (52). In this figure, for the sake of clarity, the nanotubes or nanowires (54) are only shown in one substrate pore (53).

A two-dimensional material layer may comprise, consist essentially of, or consist of one or more two-dimensional materials. In some embodiments, two-dimensional materials are atomically thin, with thickness ranging from single-layer sub-nanometer thickness to a few nanometers. Two-dimensional materials include metal chalogenides (e.g., transition metal dichalogenides), transition metal oxides, hexagonal boron nitride, graphene, silicene, molybdenum disulphide, and germanene (see: Xu et al. (2013) “Graphene-like Two-Dimensional Materials) Chemical Reviews 113:3766-3798). In some embodiments, the two-dimensional material comprises, consists essentially of, or consists of a graphene-based material.

Graphene represents a form of carbon in which the carbon atoms reside within a single atomically thin sheet or a few layered sheets (e.g., about 20 or less) of fused six-membered rings forming an extended sp2-hybridized carbon planar lattice. Graphene-based materials include, but are not limited to, single layer graphene, multilayer graphene or interconnected single or multilayer graphene domains and combinations thereof. In some embodiments, graphene-based materials also include materials which have been formed by stacking initially separate single or multilayer graphene sheets. In some embodiments, multilayer graphene includes 2 to 20 layers, 2 to 10 layers or 2 to 5 layers. In some embodiments, layers of multilayered graphene are stacked, but are less ordered in the z direction (perpendicular to the basal plane) than a thin graphite crystal.

In some embodiments, a sheet of graphene-based material may be a sheet of single or multilayer graphene or a sheet comprising a plurality of interconnected single or multilayer graphene domains, which may be observed in any known manner such as using for example small angle electron diffraction, transmission electron microscopy, etc. In some embodiments, the multilayer graphene domains have 2 to 5 layers or 2 to 10 layers. A domain may refer to a region of a material where atoms are substantially uniformly ordered into a crystal lattice. A domain is uniform within its boundaries, but may be different from a neighboring region. For example, a single crystalline material has a single domain of ordered atoms. In some embodiments, at least some of the graphene domains are nanocrystals, having domain size from 1 to 100 nm or 10-100 nm. In some embodiments, at least some of the graphene domains have a domain size greater than from 100 nm to 1 cm, or from 100 nm to 1 micron, or from 200 nm to 800 nm, or from 300 nm to 500 nm, from 300 nm to 1 cm, or from 300 nm to 10 cm. In some embodiments, a domain of multilayer graphene may overlap a neighboring domain. Grain boundaries formed by crystallographic defects at edges of each domain may differentiate between neighboring crystal lattices. In some embodiments, a first crystal lattice may be rotated relative to a second crystal lattice, by rotation about an axis perpendicular to the plane of a sheet, such that the two lattices differ in crystal lattice orientation.

In some embodiments, the sheet of graphene-based material is a sheet of single or multilayer graphene or a combination thereof. In some other embodiments, the sheet of graphene-based material is a sheet comprising a plurality of interconnected single or multilayer graphene domains. In some embodiments, the interconnected domains are covalently bonded together to form the sheet. When the domains in a sheet differ in crystal lattice orientation, the sheet is polycrystalline.

In some embodiments, the thickness of the sheet of graphene-based material is from 0.3 to 10 nm, 0.34 to 10 nm, from 0.34 to 5 nm, or from 0.34 to 3 nm. In some embodiments, the thickness includes both single layer graphene and the non-graphenic carbon.

In some embodiments, a sheet of graphene-based material comprises intrinsic or native defects. Intrinsic or native defects may result from preparation of the graphene-based material in contrast to perforations which are selectively introduced into a sheet of graphene-based material or a sheet of graphene. Such intrinsic or native defects may include, but are not limited to, lattice anomalies, pores, tears, cracks or wrinkles. Lattice anomalies can include, but are not limited to, carbon rings with other than 6 members (e.g., 5, 7 or 9 membered rings), vacancies, interstitial defects (including incorporation of non-carbon atoms in the lattice), and grain boundaries. Perforations are distinct from openings in the graphene lattice due to intrinsic or native defects or grain boundaries, but testing and characterization of the final membrane such as mean pore size and the like encompasses all openings regardless of origin since they are all present.

In some embodiments, graphene is the dominant material in a graphene-based material. For example, a graphene-based material may comprise at least 20% graphene, at least 30% graphene, or at least 40% graphene, or at least 50 % graphene, or at least 60% graphene, or at least 70 % graphene, or at least 80 % graphene, or at least 90% graphene, or at least 95% graphene. In some embodiments, a graphene-based material comprises a range of graphene selected from 30% to 95%, or from 40% to 80 % from 50 % to 70 %, from 60% to 95% or from 75% to 100%. The amount of graphene in the graphene-based material is quantified as an atomic percentage utilizing known methods including scanning transmission electron microscope examination, or alternatively if STEM or TEM is ineffective another similar measurement technique.

In some embodiments, a sheet of graphene-based material further comprises non-graphenic carbon-based material located on at least one surface of the sheet of graphene-based material. In some embodiments, the sheet is exemplified by two base surfaces (e.g., top and bottom faces of the sheet, opposing faces) and side faces (e.g., the side faces of the sheet). In some further embodiments, the bottom face of the sheet is that face which contacted the substrate during growth of the sheet and the free face of the sheet opposite the bottom face. In some embodiments, non-graphenic carbon-based material may be located on one or both base surfaces of the sheet (e.g., the substrate side of the sheet and/or the free surface of the sheet). In some further embodiments, the sheet of graphene-based material includes a small amount of one or more other materials on the surface, such as, but not limited to, one or more dust particles or similar contaminants.

In some embodiments, the amount of non-graphenic carbon-based material is less than the amount of graphene. In some further embodiments, the amount of non-graphenic carbon material is three to five times the amount of graphene; this is measured in terms of mass. In some additional embodiments, the non-graphenic carbon material is characterized by a percentage by mass of said graphene-based material selected from the range of 0% to 80%. In some embodiments, the surface coverage of the sheet of non-graphenic carbon-based material is greater than zero and less than 80%, from 5% to 80%, from 10% to 80%, from 5% to 50% or from 10% to 50%. This surface coverage may be measured with transmission electron microscopy, which gives a projection. In some embodiments, the amount of graphene in the graphene-based material is from 60% to 95% or from 75% to 100%. The amount of graphene in the graphene-based material is measured as an atomic percentage utilizing known methods preferentially using transmission electron microscope examination, or alternatively if STEM is ineffective using an atomic force microscope.

In some embodiments, the non-graphenic carbon-based material does not possess long range order and is classified as amorphous. In some embodiments, the non-graphenic carbon-based material further comprises elements other than carbon and/or hydrocarbons. In some embodiments, non-carbon elements which may be incorporated in the non-graphenic carbon include hydrogen, oxygen, silicon, copper, and iron. In some further embodiments, the non-graphenic carbon-based material comprises hydrocarbons. In some embodiments, carbon is the dominant material in non-graphenic carbon-based material. For example, a non-graphenic carbon-based material in some embodiments comprises at least 30% carbon, or at least 40% carbon, or at least 50% carbon, or at least 60% carbon, or at least 70% carbon, or at least 80% carbon, or at least 90% carbon, or at least 95% carbon. In some embodiments, a non-graphenic carbon-based material comprises a range of carbon selected from 30% to 95%, or from 40% to 80%, or from 50% to 70%. The amount of carbon in the non-graphenic carbon-based material is measured as an atomic percentage utilizing known methods preferentially using transmission electron microscope examination, or alternatively if STEM is ineffective using atomic force microscope.

Perforation techniques suitable for use in perforating the graphene-based materials may include ion-based perforation methods and UV-oxygen based methods.

Ion-based perforation methods include methods in which the graphene-based material is irradiated with a directional source of ions. In some further embodiments, the ion source is collimated. In some embodiments, the ion source is a broad beam or flood source. A broad field or flood ion source can provide an ion flux which is significantly reduced compared to a focused ion beam. The ion source inducing perforation of the graphene or other two-dimensional material may be considered to provide a broad ion field, sometimes referred to as an ion flood source. In some embodiments, the ion flood source does not include focusing lenses. In some embodiments, the ion source is operated at less than atmospheric pressure, such as at 10⁻³ to 10⁻⁵ torr or 10⁻⁴ to 10⁻⁶ torr. In some embodiments, the environment also contains background amounts (e.g., on the order of 10⁻⁵ torr) of oxygen (O₂), nitrogen (N₂) or carbon dioxide (CO₂). In some embodiments, the ion beam may be perpendicular to the surface of the layer(s) of the material (incidence angle of 0 degrees) or the incidence angle may be from 0 to 45 degrees, 0 to 20 degrees, 0 to 15 degrees or 0 to 10 degrees. In some further embodiments, exposure to ions does not include exposure to plasma.

In some embodiments, UV-oxygen based perforation methods include methods in which the graphene-based material is simultaneously exposed to ultraviolet (UV) light and an oxygen containing gas Ozone may be generated by exposure of an oxygen containing gas such as oxygen or air to the UV light. Ozone may also be supplied by an ozone generator device. In some embodiments, the UV-oxygen based perforation method further includes exposure of the graphene-based material to atomic oxygen. Suitable wavelengths of UV light include, but are not limited to wavelengths below 300 nm or from 150 nm to 300 nm. In some embodiments, the intensity from 10 to 100 mW/cm² at 6 mm distance or 100 to 1000 mW/cm² at 6 mm distance. For example, suitable light is emitted by mercury discharge lamps (e.g., about 185 nm and 254 nm). In some embodiments, UV/oxygen cleaning is performed at room temperature or at a temperature greater than room temperature. In some further embodiments, UV/oxygen cleaning is performed at atmospheric pressure (e.g., 1 atm) or under vacuum.

In some embodiments, nanoparticle-based perforation methods are used in perforating the graphene-based materials. Non-limiting examples of nanoparticle-based perforation methods are described in US 20170036916, which is incorporated by reference herein in its entirety.

Perforations are sized to provide desired selective permeability of a species (e.g., atom, molecule, virus, etc.) for a given application including by way of example the encapsulations of U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially for their description of encapsulation techniques and biological environmental parameters. Selective permeability relates to the propensity of a porous material or a perforated two-dimensional material to allow passage (or transport) of one or more species more readily or faster than other species. Selective permeability allows separation of species which exhibit different passage or transport rates. In two-dimensional materials selective permeability correlates to the dimension or size (e.g., diameter) of apertures and the relative effective size of the species. Selective permeability of the perforations in two-dimensional materials such as graphene-based materials can also depend on functionalization of perforations (if any) and the specific species. Separation or passage of two or more species in a mixture includes a change in the ratio(s) (weight or molar ratio) of the two or more species in the mixture during and after passage of the mixture through a perforated two-dimensional material.

In some embodiments, the characteristic size of the perforation is from 0.3 to 10 nm, from 1 to 10 nm, from 5 to 10 nm, from 5 to 20 nm, from 10 nm to 50 nm, from 50 nm to 100 nm, from 50 nm to 150 nm, from 100 nm to 200 nm, or from 100 nm to 500 nm. In some embodiments, the average pore size is within the specified range. In some embodiments, 70% to 99%, 80% to 99%, 85% to 99% or 90 to 99% of the perforations in a sheet or layer fall within a specified range, but other perforations fall outside the specified range.

Nanomaterials in which pores or perforations are intentionally created may be referred to as perforated graphene, perforated graphene-based materials or perforated two-dimensional materials, and the like. Perforated graphene-based materials include materials in which non-carbon atoms have been incorporated at the edges of the pores. Pore features and other material features may be characterized in a variety of manners including in relation to size, area, domains, periodicity, coefficient of variation, etc. For instance, the size of a pore may be assessed through quantitative image analysis utilizing images preferentially obtained through transmission electron microscopy, and if TEM is ineffective, through atomic force microscopy, and if AFM is ineffective, through scanning electron microscopy. The boundary of the presence and absence of material identifies the contour of a pore. The size of a pore may be determined by shape fitting of an expected species against the imaged pore contour where the size measurement is characterized by smallest dimension unless otherwise specified. For example, in some instances, the shape may be round or oval. The round shape exhibits a constant and smallest dimension equal to its diameter. The width of an oval is its smallest dimension. The diameter and width measurements of the shape fitting in these instances provide the size measurement, unless specified otherwise.

Each pore size of a test sample may be measured to determine a distribution of pore sizes within the test sample. Other parameters may also be measured such as area, domain, periodicity, coefficient of variation, etc. Multiple test samples may be taken of a larger membrane to determine that the consistency of the results properly characterizes the whole membrane. In such instance, the results may be confirmed by testing the performance of the membrane with test species. For example, if measurements indicate that certain sizes of species should be restrained from transport across the membrane, a performance test provides verification with test species. Alternatively, the performance test may be utilized as an indicator that the pore measurements will determine a concordant pore size, area, domains, periodicity, coefficient of variation, etc.

The size distribution of holes may be narrow, e.g., limited to 0.1-0.5 coefficient of variation. In some embodiments, the characteristic dimension of the holes is selected for the application.

In some embodiments involving circular shape fitting the equivalent diameter of each pore is calculated from the equation A=π d²/4. Otherwise, the area is a function of the shape fitting. When the pore area is plotted as a function of equivalent pore diameter, a pore size distribution may be obtained. The coefficient of variation of the pore size may be calculated as the ratio of the standard deviation of the pore size to the mean of the pore size as measured across the test samples. The average area of perforations is an averaged measured area of pores as measured across the test samples.

In some embodiments, the ratio of the area of the perforations to the ratio of the area of the sheet may be used to characterize the sheet as a density of perforations. The area of a test sample may be taken as the planar area spanned by the test sample. Additional sheet surface area may be excluded due to wrinkles other non-planar features. Characterization may be based on the ratio of the area of the perforations to the test sample area as density of perforations excluding features such as surface debris. Characterization may be based on the ratio of the area of the perforations to the suspended area of the sheet. As with other testing, multiple test samples may be taken to confirm consistency across tests and verification may be obtained by performance testing. The density of perforations may be, for example, 2 per nm2 (2/nm²) to 1 per μm²(1/μm²).

In some embodiments, the perforated area comprises 0.1% or greater, 1% or greater or 5% or greater of the sheet area, less than 10% of the sheet area, less than 15% of the sheet area, from 0.1% to 15% of the sheet area, from 1% to 15% of the sheet area, from 5% to 15% of the sheet area or from 1% to 10% of the sheet area. In some further embodiments, the perforations are located over greater than 10% or greater than 15% of said area of said sheet of graphene-based material. A macroscale sheet is macroscopic and observable by the naked eye. In some embodiments, at least one lateral dimension of the sheet is greater than 3 cm, greater than 1 cm, greater than 1 mm or greater than 5 mm. In some further embodiments, the sheet is larger than a graphene flake which would be obtained by exfoliation of graphite in known processes used to make graphene flakes. For example, the sheet has a lateral dimension greater than about 1 micrometer. In some additional embodiments, the lateral dimension of the sheet is less than 10 cm. In some further embodiments, the sheet has a lateral dimension (e.g., perpendicular to the thickness of the sheet) from 10 nm to 10 cm or greater than 1 mm and less than 10 cm.

Chemical vapor deposition growth of graphene-based material typically involves use of a carbon containing precursor material, such as methane and a growth substrate. In some embodiments, the growth substrate is a metal growth substrate. In some embodiments, the metal growth substrate is a substantially continuous layer of metal rather than a grid or mesh. Metal growth substrates compatible with growth of graphene and graphene-based materials include transition metals and their alloys. In some embodiments, the metal growth substrate is copper based or nickel based. In some embodiments, the metal growth substrate is copper or nickel. In some embodiments, the graphene-based material is removed from the growth substrate by dissolution of the growth substrate.

In some embodiments, the sheet of graphene-based material is formed by chemical vapor deposition (CVD) followed by at least one additional conditioning or treatment step. In some embodiments, the conditioning step is selected from thermal treatment, UV-oxygen treatment, ion beam treatment, and combinations thereof In some embodiments, thermal treatment may include heating to a temperature from 200° C. to 800° C. at a pressure of 10⁻⁷ torr to atmospheric pressure for a time of 2 hours to 8 hours. In some embodiments, UV-oxygen treatment may involve exposure to light from 150 nm to 300 nm and an intensity from 10 to 100 mW/cm² at 6 mm distance for a time from 60 to 1200 seconds. In some embodiments, UV-oxygen treatment may be performed at room temperature or at a temperature greater than room temperature. In some further embodiments, UV-oxygen treatment may be performed at atmospheric pressure (e.g., 1 atm) or under vacuum. In some embodiments, ion beam treatment may involve exposure of the graphene-based material to ions having an ion energy from 50 eV to 1000 eV (for pretreatment) and the fluence is from 3×10¹⁰ ions/cm² to 8×10¹¹ ions/cm² or 3×10¹⁰ ions/cm² to 8×10¹³ ions/cm² (for pretreatment). In some further embodiments, the source of ions may be collimated, such as a broad beam or flood source. In some embodiments, the ions may be noble gas ions such as Xe⁺. In some embodiments, one or more conditioning steps are performed while the graphene-based material is attached to a substrate, such as a growth substrate.

In some embodiments, the conditioning treatment affects the mobility and/or volatility of the non-graphitic carbon-based material. In some embodiments, the surface mobility of the non-graphenic carbon-based material is such that when irradiated with perforation parameters, the non-graphenic carbon-based material, may have a surface mobility such that the perforation process results ultimately in perforation. Without wishing to be bound by any particular belief, hole formation is believed to be related to beam induced carbon removal from the graphene sheet and thermal replenishment of carbon in the hole region by non graphenic carbon. The replenishment process may be dependent upon energy entering the system during perforation and the resulting surface mobility of the non-graphenic carbon based material. To form holes, the rate of graphene removal may be higher than the non-graphenic carbon hole filling rate. These competing rates depend on the non-graphenic carbon flux (e.g., mobility [viscosity and temperature] and quantity) and the graphene removal rate (e.g., particle mass, energy, flux).

In some embodiments, the volatility of the non-graphenic carbon-based material may be less than that which is obtained by heating the sheet of graphene-based material to 500° C. for 4 hours in vacuum or at atmospheric pressure with an inert gas.

In various embodiments, CVD graphene or graphene-based material can be liberated from its growth substrate (e.g., Cu) and transferred to a supporting grid, mesh or other supporting structure. In some embodiments, the supporting structure may be configured so that at least some portions of the sheet of graphene-based material are suspended from the supporting structure. For example, at least some portions of the sheet of graphene-based material may not be in contact with the supporting structure.

In some embodiments, the sheet of graphene-based material following chemical vapor deposition comprises a single layer of graphene having at least two surfaces and non-graphenic carbon based material may be provided on said surfaces of the single layer graphene. In some embodiments, the non-graphenic carbon based material may be located on one of the two surfaces or on both. In some further embodiments, additional graphenic carbon may also present on the surface(s) of the single layer graphene.

In some embodiments, the particle beam is a nanoparticle beam or cluster beam. In some further embodiments, the beam is collimated or is not collimated. Furthermore, the beam need not be highly focused. In some embodiments, a plurality of the nanoparticles or clusters is singly charged. In additional embodiments, the nanoparticles comprise from 500 to 250,000 atoms or from 500 to 5,000 atoms.

A variety of metal particles are suitable for use in the methods of the present disclosure. For example, nanoparticles of Al, Ag, Au, Ti, Cu and nanoparticles comprising Al, Ag, Au, Ti, Cu are suitable. Metal NPs can be generated in a number of ways including magnetron sputtering and liquid metal ion sources (LMIS). Methods for generation of nanoparticles are further described in Cassidy, Cathal, et al. “Inoculation of silicon nanoparticles with silver atoms.” Scientific reports 3 (2013), Haberland, Hellmut, et al. “Filling of micron-sized contact holes with copper by energetic cluster impact.” Journal of Vacuum Science & Technology A 12.5 (1994): 2925-2930, Bromann, Karsten, et al. “Controlled deposition of size-selected silver nanoclusters.” Science 274.5289 (1996): 956-958, Palmer, R. E., S. Pratontep, and H-G. Boyen. “Nanostructured surfaces from size-selected clusters.” Nature Materials 2.7 (2003): 443-448, Shyjumon, I., et al. “Structural deformation, melting point and lattice parameter studies of size selected silver clusters.” The European Physical Journal D-Atomic, Molecular, Optical and Plasma Physics 37.3 (2006): 409-415, Allen, L. P., et al. “Craters on silicon surfaces created by gas cluster ion impacts.” Journal of applied physics 92.7 (2002): 3671-3678, Wucher, Andreas, Hua Tian, and Nicholas Winograd. “A Mixed Cluster Ion Beam to Enhance the Ionization Efficiency in Molecular Secondary Ion Mass Spectrometry.” Rapid communications in mass spectrometry: RCM 28.4 (2014): 396-400. PMC. Web. 6 Aug. 2015 and Pratontep, S., et al. “Size-selected cluster beam source based on radio frequency magnetron plasma sputtering and gas condensation.” Review of scientific instruments 76.4 (2005): 045103, each of which is hereby incorporated by reference especially for its description of nanoparticle generation techniques.

Gas cluster beams can be made when high pressure gas adiabatically expands in a vacuum and cools such that it condenses into clusters. Clusters can also be made ex situ such as C60 and then accelerated towards the graphene.

In some embodiments, the nanoparticles are specially selected to introduce moieties into the graphene. In some embodiments, the nanoparticles function as catalysts. The moieties may be introduced at elevated temperatures, optionally in the presence of a gas. In other embodiments, the nanoparticles introduce chiseling moieties, which are moieties that help reduce the amount of energy needed to remove an atom during irradiation.

In embodiments, the size of the perforation apertures is controlled by controlling both the nanoparticle size and the nanoparticle energy. Without wishing to be bound by any particular belief, if all the nanoparticles have sufficient energy to perforate, then the resulting perforation is believed to correlated with the nanoparticle sizes selected. However, the size of the perforation is believed to be influenced by deformation of the nanoparticle during the perforation process. This deformation is believed to be influenced by both the energy and size of the nanoparticle and the stiffness of the graphene layer(s). A grazing angle of incidence of the nanoparticles can also produce deformation of the nanoparticles. In addition, if the nanoparticle energy is controlled, it is believed that nanoparticles can be deposited with a large mass and size distribution, but that a sharp cutoff can still be achieved.

Without wishing to be bound by any particular belief, the mechanism of perforation is believed to be a continuum bound by sputtering on one end (where enough energy is delivered to the graphene sheet to atomize the carbon in and around the NP impact site) and ripping or fracturing (where strain induced failure opens a torn hole but leaves the graphene carbons as part of the original sheet). Part of the graphene layer may fold over at the site of the rip or fracture. In an some embodiments, the cluster can be reactive so as to aid in the removal of carbon (e.g., an oxygen cluster or having trace amounts of a molecule known to etch carbon in a gas cluster beam, i.e., a mixed gas cluster beam). Without wishing to be bound by any particular belief, the stiffness of a graphene layer is believed to be influenced by both the elastic modulus of graphene and the tautness of the graphene. Factors influencing the elastic modulus of a graphene layer are believed to include temperature, defects (either small defects or larger defects from NP irradiation), physisorption, chemisorption and doping. Tautness is believed to be influenced by coefficient of thermal expansion mismatches (e.g., between substrate and graphene layer) during deposition, strain in the graphene layer, wrinkling of the graphene layer. It is believed that strain in a graphene layer can be influenced by a number of factors including application of gas pressure to the backside (substrate side) of a graphene layer, straining of an elastic substrate prior to deposition of graphene, flexing of the substrate during deposition, and defecting the graphene layer in controlled regions to cause the layer to locally contract and increase the local strain.

In embodiments, nanoparticle perforation can be further controlled by straining the graphene layers during perforation to induce fracture, thereby ripping or tearing one or more graphene layers. In some embodiments, the stress is directional and used to preferentially fracture in a specific orientation. For example, ripping of one or more graphene sheets can be used to create slit shaped apertures; such apertures can be substantially larger than the nanoparticle used to initiate the aperture. In additional embodiments, the stress is not oriented in a particular direction.

In some embodiments, the perforated graphene-based material layer may have pores or perforations with a size sufficient to allow a pharmaceutical to pass through the pores or perforations. In some embodiments, the perforated graphene-based material layer has pores or perforations with a diameter of from about 1 nm to about 100 nm. In some embodiments, hole sizes in the perforated graphene-based material layer range in size from 1-50 nm, 1-40 nm, 1-30 nm, 1-25 nm, 1-17 nm, 1-15 nm, 1-12 nm, 1-10 nm, 3-50 nm, 3-30 nm, 3-20 nm, 3-10 nm, or 3-5 nm. In some embodiments, the size of the holes is about 1 nm, about 3 nm about 5 nm, about 10 nm, about 15 nm, about 20 nm, about 30 nm, about 50 nm, about 60 nm, about 70 nm, about 80 nm, about 90 nm, or about 100 nm. Pore sizes in the perforated graphene can be tailored to selectively exclude various substances based, e.g., on size. A pharmaceutical and a drug may be used interchangeably. Unless otherwise noted, a pharmaceutical may be smaller in size than a biological constituents.

With regard to nanoparticle-based perforation methods, in some embodiments, the methods involve exposing the two-dimensional material layer to a particle beam comprising nanoparticles (NPs) or clusters having an energy of about 2 keV or greater (per nanoparticle or clusters) to perforate the two-dimensional material layer. In some embodiments, the nanoparticles are metal nanoparticles, carbon nanoparticles, gas clusters and/or core shell structure nanoparticles.

In embodiments, the nanoparticle or cluster energy may be greater than or equal to about 2 keV but less than about 500 keV, greater than 2 keV and less than 100 keV, greater than 2 keV and less than 50 keV or greater than or equal to 2 keV and less than or equal to 30 keV. In some further embodiments, the nanoparticle may comprise a plurality of atoms and the energy is from 0.05 eV to 50 eV per atom, 0.1 eV to 50 eV per atom, or 1 eV to 1 keV per atom. In some further embodiments, the fluence is 1×10⁸-1×10¹² NPs/cm². In embodiments the nanoparticle perforation efficiency is from 1% to 100%. In some aspects with some embodiments, the nanoparticle-based perforation methods further include steps for nanoparticle generation and subsequent acceleration. In an example, the potential is from 1 to 100 kV. In some instances additional ionization is done such as electron impact and electrospray to provide additional energy to the NPs for perforations. For NPs columbic limitation may limit the amount of charge (too much charge may cause the particle to fragment). In some embodiments, the charge is up to 4 e.

In some embodiments, the nanoparticles are from 1 nm to 100 nm, 1 nm to 50 nm, 2 nm to 50 nm, 1 nm to 25 nm, 2 nm to 25 nm, 2 nm to 10 nm, 3 nm to 30 nm, or 10 nm to 50 nm in size. In some instances the NPs are characterized by a uniform size distribution, in other instances by a Gaussian size distribution, in some cases by a normal distribution and still further in other instances in a bimodal distribution. When the NPs are provided in a biomodal distribution, in some embodiments both modes are used for perforation and in some other embodiments one mode is utilized for perforation and the other for adding additional energy to the graphene. In additional embodiments, the distribution of NP sizes is not a standard distribution.

In some embodiments, the graphene-based material is pretreated before exposure to the beam of nanoparticles. In some embodiments, a graphene-based material is pretreated as a unit. In some embodiments the whole layer is treated while in some other embodiments the selected regions of the sheet are treated. As an example, selected regions of the sheet are treated so that the sheet as whole perforates uniformly. In some embodiments, the pretreatment process introduces point defects into one or more sheets of graphene. In some further embodiments, the pretreatment process introduces pores having an average size less than 1 nm. In some embodiments, the pretreatment step is selected from thermal treatment, UV-oxygen treatment, ion beam treatment, and combinations thereof. In some embodiments, the graphene-based materials are irradiated with a broad ion beam having an ion energy from 50 eV to 10 keV and a fluence from 3×10¹⁰ ions/cm² to 8×10¹¹ ions/cm² or 3×10¹⁰ ions/cm² to 8×10¹³ ions/cm². In some embodiments, the irradiation time is from 0.1 milliseconds to less than 10 seconds, from 1 millisecond to less than 10 seconds, from 1 second to 100 seconds, or from 10 second to 1000 seconds. In general, if relatively small areas are irradiated then the times are lower than when relatively larger areas are irradiated. In some further embodiments, the pretreatment process irradiates the graphene to introduce moieties into the graphene lattice to weaken it and make it more easily perforated with nanoparticles. Such a pretreatment process can enable chemically assisted perforation. An example of such a moiety is an oxygen containing compound. In embodiments, suitable moieties are introduced with nanoparticle pretreatment.

In some embodiments, the graphene-based material is non-perforated prior to exposure to the nanoparticle beam. In some further embodiments, the graphene-based material is perforated prior to exposure to the nanoparticle beam (“pre-perforated”). In some embodiments a first layer of graphene is perforated, and then subsequently additional layers of graphene are perforated after the additional layers are applied to the first layer. A variety of perforation methods are known to the art, including ion-based methods and oxidation based methods. In some embodiments, the pre-perforated graphene-based material comprises a first set of pores having a first pore size and exposure to the nanoparticle beam then modifies the pre-perforated sheet of graphene-based material. In some embodiments, the modification includes creating a second set of pores having a second pore size extending through the multiple graphene sheets, modifying the first pore size or combinations thereof. In embodiments, the pore size of the perforated graphene-based materials has a bimodal distribution. Exemplary combinations of pore sizes include, but are not limited to a combination of pores with a size less than 3 nm and pores with a size greater than 15 nm and less than or equal to 100 nm. The combinations could be formed through a combination of pre-perforation and NP perforation, but also could be formed from combinations of NP perforation. In some embodiments, the ratio of the area of pores with a size less than 3 nm to the area of the sheet is from 1 to 10% while the ratio of the area of pores with a size greater than 15 nm and less than or equal to 100 nm to the area of the sheet is from 1 to 10%.

In some further embodiments, the perforated sheet of graphene-based material may be modified with a post-perforation treatment process. Exemplary post-perforation treatment processes include, but are not limited to, further dilation of the pores, reshaping of the pores, stabilization of the pores and increasing the fracture toughness of the sheet. In embodiments, further dilation of the pores may be achieved by irradiating the perforated graphene sheet with a broad ion beam. In some embodiments, the ions are selected from the group consisting of Xe, Ne, He, Ga and Ar and the ion energy ranges from 5 eV or 40 keV and the ion flux or beam density ranges from 1×10¹² ions/cm²/s to 1×10¹³ ions/cm²/s, and fluences from 6.24×10¹³ ions/cm² to 6.24×10¹⁴ ions/cm². In some embodiments, the ions are selected from the group consisting of Xe, Ne, and Ar, the ion energy ranges from 5 eV to 40 keV, with some exemplary embodiments of 100 eV to 1000 eV and the ion dose ranges from 1×10¹³ ions/cm² to 5×10¹⁵ ions/cm². In some embodiments, the ion energy ranges from 1 keV to 40 keV and the ion dose ranges from 1×10¹⁹ ions/cm² to 1×10²¹ ions/cm². In some embodiments, the ion energy is 300 V and the ion dose is 1×10¹⁴ ions/cm². In some further embodiments, a rastered focused ion beam can be used instead of a broad ion beam. In some further embodiments, dilation of the pores is accompanied by an increase in the overall percentage of porosity.

In additional embodiments, reshaping of the pores may be achieved by irradiating the perforated graphene sheet with a broad ion beam. In some embodiments, the ions are selected from the group consisting of Xe ions, Ne ions, and Ar ions and the ion energy ranges from 10 eV to 10 keV and the ion flux or beam density ranges from 1×10¹² ions/cm²/s to 1×10¹³ ions/cm²/s, and fluences from 6.24×10¹³ ions/cm² to 6.24×10¹⁴ ions/cm². In some further embodiments, stabilization of the pores may be achieved by irradiating the perforated graphene sheet with a broad ion beam, wherein the ions of the broad ion beam have an ion energy from 5 eV to 40 k eV and a fluence from 1×10¹⁰ ions/cm² to 1×10²¹ ions/cm². In some embodiments, the irradiation time is from 1 ms to 100 s. In some further embodiments, the fracture toughness of the perforated sheet may be achieved by irradiating the perforated graphene sheet with a broad ion beam, wherein the ions of the broad ion beam have an ion energy from 50 eV to 1000 eV and a fluence from 3×10¹⁰ ions/cm² to 8×10¹¹ ions/cm². Other methods for dilating, reshaping and/or stabilizing the pores include, but are not limited to exposure to ultraviolet light and oxygen, use of a carbon-selective etching solution, and application of heat. Electron irradiation could also be applied with energies in the 10-300 keV range.

The nanoparticle-based perforation methods may further comprise one or more of the following features. In some embodiments, the sheet of graphene-based material or the sheet comprising a graphene-based material is heated. For example, heating may add energy to the system. If an appropriate coefficient of thermal expansion (CTE) mismatch with the substrate occurs, heating may strain the graphene for perforation. Suitable heating methods include, but are not limited to, Joule heating of the graphene-based material, IR radiation, heating via a conductive plate, or any combination of the above. In embodiments, the graphene layers are tilted relative to the incidence angle of the impinging NPs. In some further embodiments, this tilt is greater than zero and less than or equal to 89 degrees, is greater than 30 degrees and less than or equal to 89 degrees, or is from 45 degrees to 70 degrees. In some embodiments, an incidence angle of collimated nanoparticles may be referenced normal to the basal plane of the top-most sheet of graphene or other material. In additional embodiments, a trace amount of gas or other material containing an element or moiety of interest for functionalization of pore edges is present before NP perforation, during NP perforation, after NP perforation or any combination thereof to functionalize pores produced by the NPs. The gas may be introduced on the front side, back side, or both sides of the sheet of graphene-based material. In additional embodiments, a trace amount of a gas is present during NP perforation and/or after NP perforation to etch pores produced by the NPs. In some embodiments, the pressure of gas is less than 10⁻³ Torr. In some embodiments, the graphene-based material is pressurized with a gas from behind during exposure to the nanoparticle beam. In some embodiments, the gas pressure strains the graphene-based material during perforation. In some embodiments, the gas is used to functionalize the pores once the pores are produced.

The preferred gases for before and during functionalization would depend on the reaction of graphene and the gas within the high energy environment of the particle impact. This would be within about 100 nm of the edge of the particle impact. This fits into two general classes, and the gases would be added at a partial pressure of from 1×10⁻⁶ Torr to 1×10⁻³ Torr. The first class would be species that reacts with radicals, carbanions (negative charge centered on a carbon) and carbocations (positive charge centered on a carbon). Representative molecules include carbon dioxide, ethylene oxide and isoprene. The second class would be species that fragment to create species that react with graphene and defective graphene. Representative molecules would be polyethylene glycol, diacytylperoxide, azobisisobutyronitrile, and phenyl diazonium iodide.

In some embodiments, the nanoparticle-based perforation methods comprise the use of a mask to limit perforation by the nanoparticles. The mask is placed in front of the graphene layer(s) with respect to the source of nanoparticles. In embodiments, the mask includes openings and nanoparticle perforation preferentially occurs through openings in the mask. Exemplary masks include, but are not limited to, masks formed from self-assembled bead layers, masks formed by selective etching of block co-polymer layers, masks formed by soft landing of nanoparticles, masks of patterned metal or polymer layers and masks formed from perforated graphene. Exemplary block co-polymer masks are described in Kim et al. “Fabrication and Characterization of Large Area, Semiconducting Nanoperforated Graphene Materials,” Nano Letters 2010 Vol. 10, No. 4, Mar. 1, 2010, pp 1125-1131). As another example, a polymeric photoresist can be used to make a patterned polymer layer via lithography. In some embodiments, a patterned metal layer can serve as both a mask and as an electrode.

In some embodiments, the barrier layer may comprise at least one perforated graphene layer. In some embodiments, the barrier layer may comprise at least two, or at least three, or at least four, or at least five, or at least six, or at least seven, or at least eight, or at least nine, or at least ten perforated graphene layers. In some embodiments, the barrier layer may comprise up to ten perforated graphene layers. In some embodiments, the barrier layer may comprise 1, 2, 3, 4, 5, 6, 7, 8, 9, or 10 perforated graphene layers. In some embodiments, the barrier layer may comprise 1-10 perforated graphene layers.

In some embodiments, the barrier layer may be positioned as an outermost layer of the membrane.

In some embodiments, the membrane comprises one substrate layer and the substrate layer is directly disposed on the barrier layer. In some embodiments, the membrane comprises one substrate layer and the substrate layer is indirectly disposed on the barrier layer.

In some embodiments, the porous layer devoid of nanotubes or nanowires promotes adhesion between the barrier layer and the substrate layer. Thus, in some embodiments, the enclosure comprises a porous layer devoid of nanotubes or nanowires disposed between the barrier layer (e.g., two-dimensional material layer) and the substrate layer. In some embodiments, the enclosure comprises a porous layer devoid of nanotubes or nanowires positioned between two substrate layers on the same side of the two-dimensional material layer.

Suitable techniques for depositing or forming a porous or permeable polymer on the barrier layer (e.g., two-dimensional material layer) include casting or depositing a polymer solution (with nanotubes or nanowires dispersed within the solution) onto the barrier layer or porous layer devoid of nanotubes or nanowires using a method such as spin-coating, spray coating, curtain coating, doctor-blading, immersion coating, electrospinning, or other similar techniques. Electrospinning techniques are described, e.g., in US 2009/0020921 and/or U.S. application Ser. No. 14/609,325, both of which are hereby incorporated by reference in their entirety.

In some embodiments, both the two-dimensional material layer and the substrate layer include a plurality of pores therein. In some embodiments, both the two-dimensional material and the substrate layer contain pores, and the pores in the two-dimensional material layer are smaller, on average, than the pores in the substrate layer. In some embodiments, the median pore size in the two dimensional material layer is smaller than the median pore size in the substrate layer. For example, in some embodiments, the substrate layer can contain pores with an average and/or median diameter of about 1 μm or larger and the two-dimensional material layer can contain pores with an average and/or median diameter of about 10 nm or smaller. Accordingly, in some embodiments, the average and/or median diameter of pores in the two-dimensional material layer is at least about 10-fold smaller than the average and/or median diameter of pores in the substrate layer. In some embodiments, the average and/or median diameter of pores in the two-dimensional material layer is at least about 100-fold smaller than are the average and/or media diameter of pores in the substrate layer.

In some embodiments, the membrane further comprises an intermediate layer. In some embodiments, the membrane further comprises an intermediate layer positioned between the substrate layer and the barrier layer. In some embodiments, the membrane further comprises an intermediate layer positioned between the substrate layer and the two-dimensional material layer. In some embodiments, the membrane further comprises an intermediate layer positioned between the substrate layer and the perforated graphene-based material layer. In some embodiments, the membrane further comprises an intermediate layer positioned between the porous layer devoid of nanotubes or nanowires and the barrier layer.

In some embodiments, the intermediate layer promotes adhesion between the barrier layer and the substrate layer. Thus, in some embodiments, the membrane comprises an intermediate layer disposed between the barrier layer and the substrate layer. In some embodiments, the intermediate layer promotes adhesion between the barrier layer and the porous layer devoid of nanotubes or nanowires. Thus, in some embodiments, the membrane comprises an intermediate layer disposed between the barrier layer and the porous layer devoid of nanotubes or nanowires.

In some embodiments, the intermediate layer comprises carbon nanotubes, carbon nanostructures (CNS), electrospun polymer (such as, but not limited to, polyamide, polyester, polyacrylonitrile, polyphenylene sulfide, polysulfone, polyurethane, polyvinylidene fluoride, or a combination of any two or more thereof), lacey carbon, nanoparticles, patterned low-dimensional materials, silicon and silicon nitride micromachined material, a fine mesh, (such as, but not limited to, a transmission electron microscopy grid), hydrogel infusion, or combinations of these. In some embodiments, the intermediate layer may be a thin, smooth, porous polymer layer, such as a track etched polymer. In some embodiments, the intermediate layer may comprise CNS. In some embodiments, the intermediate layer has a thickness of from 3 nm to 10 μm, 10 nm to 10 μm, 50 nm to 10 μm, 100 nm to 10 μm, 500 nm to 10 μm, 1 μm to 10 μm, or 2 μm to 6 μm. In some embodiments, the composite structure has a thickness of from 1 μm to 100 μm, 2 μm to 75 μm, 3 μm to 50 μm, 4 μm to 40 μm, 5 μm to 30 μm, 6 μm to 25 μm, or 6 μm to 20 μm, or 6 μm to 16 μm.

Carbon nanostructure or CNS may refer to a plurality of carbon nanotubes that can exist as a polymeric structure by being interdigitated, branched, crosslinked, and/or by sharing common walls with one another. A carbon nanostructure can be considered to have a carbon nanotube as a base monomer unit of its polymeric structure. Carbon nanostructures can be produced by growing carbon nanotubes on a fiber material and then removing the formed carbon nanostructures therefrom in the form of a flake material, as described in U.S. patent application Ser. No. 14/035,856 (U.S. published application 2014/0093728), which is incorporated herein by reference in its entirety. In some embodiments, the carbon nanostructures can contain carbon nanotubes of about 10-20 nm in diameter and about a 30 nm pitch, leading to an effective average pore diameter of about 30 nm to about 50 nm in a range of about 10 nm to about 150 nm. Carbon nanostructures are believed to differ structurally from carbon nanotubes that have been chemically crosslinked following synthesis of the carbon nanotubes. In alternative embodiments, carbon nanostructures that remain fused to the fiber material upon which they are grown can also be used as the intermediate layer.

Modified carbon nanostructures are believed to differ from unmodified carbon nanostructures in their ability to support graphene, graphene-based or other two-dimensional materials. In some embodiments, a thin layer of carbon nanostructures is deposited on the surface of a substrate layer (e.g., from a liquid dispersion of carbon nanostructures), and the layer of CNS is allowed to dry. The carbon nanostructures or the layer formed therefrom can be chemically modified to be self-smoothing so that a conformal layer upon the structural substrate results, such that the carbon nanostructure layer has sufficient surface smoothness for applying graphene or another two- dimensional material thereon. Mats of unmodified carbon nanostructures, in contrast, are not believed to form a conformal coating on the substrate layer with enough surface smoothness to effectively support the graphene or other two-dimensional material thereon. The chemical treatments to create a smooth CNS layer can involve thermal treatments in an oxidizing environment such as air, acid treatment, activation with strong alkaline solution or molten alkaline compounds, or plasma treatment. Additionally, surfactants (including anionic, cationic, nonionic and polar polymers, such as PVP and PVA in an aqueous solution) can also be employed to facilitate the dispersion of the CNS to form a smooth layer. In some embodiments, the layer of carbon nanostructures can have a thickness of about 1000 nm or less, particularly about 500 nm or less.

Because carbon nanostructures are composed of interwoven carbon nanotubes that are very similar in composition to graphene sheets, a layer of CNS can be extremely strong while still behaving on the surface of the substrate layer much in the same way the graphene would. Moreover, the compositional similarity of carbon nanostructures to graphene can facilitate strong molecular interactions (e.g., pi-pi bonding, van der Waals forces, etc.) or other non-bonding carbon-carbon interactions between the carbon nanostructures and the graphene itself. Thus, by building up the surfaces of previously unusable structural substrates, such as nanofiber structural membranes, and rougher polymers such as nylon, PVDF and PES, gaps can be bridged upon the surface of the substrate layer with the CNS material (e.g. , between the fibers or other rough surface) to provide a smooth interface for compliant graphene coverage while still retaining a high level of permeability. The CNS can furthermore promote adhesion of the graphene to an otherwise unsuitable substrate layer.

In some embodiments, the membrane may comprise two or more substrate layers and a weight percentage of nanotubes or nanowires is not the same for all of the substrate layers. In one non-limiting example, the membrane may have two substrate layers with a different weight percentage of nanotubes or nanowires in each substrate layer. In another non-limiting example, the membrane may have three substrate layers with a different weight percentage of nanotubes or nanowires in each substrate layer. In another non-limiting example, the membrane may have three substrate layers with two substrate layers that have the same weight percentage of nanotubes or nanowires but a third layer has a different weight percentage of nanotubes or nanowires relative to the first two.

In some embodiments, the membrane may comprise two or more substrate layers and the nanotubes or nanowires within each substrate layer do not comprise the same material. In one non-limiting example, the membrane may have two substrate layers, with one substrate layer comprising carbon nanotubes or carbon nanowires and the other substrate layer comprising nanotubes or nanowires containing elemental metal.

In some embodiments, the membrane is patterned on at least one side of the membrane to increase biocompatibility and/or to promote engraftment. In some embodiments, the membrane is patterned on one side of the membrane to increase biocompatibility and/or to promote engraftment. In some embodiments, the membrane is patterned on both sides of the membrane to increase biocompatibility and/or to promote engraftment. In some embodiments, the pattern may be random. In some embodiments, the pattern may not be random. In some embodiments, the pattern may be applied by microsphere indentation. In some embodiments, the pattern may be applied by the creation of grooves.

Enclosures

The membranes may form various enclosures and encapsulation devices which can be in any shape including cylinders, flat sheets, disks, etc. such as referred to in such documents as, for example, U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially in relation to various sizes and shapes of macroencapsulation devices.

Some embodiments facilitate selective passage of substances through the enclosure macroencapsulation that encourage nearby vascularization (i.e., angiogenesis) and/or tissue ingrowth in a biological environment in various manners, including such as described by way of example in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially for the discussion os vascularization and tissue growth.

Some embodiments include methods and devices for selectively separating or isolating substances in a biological environment using at least a membrane. Some embodiments include an enclosure comprising a compartment and a wall separating the compartment from an environment external to the compartment. In some embodiments, the wall comprises a membrane and substrate.

The enclosures can house various substances therein allowing movement of selected substances to and from the interior of the enclosure, retaining other selected substances therein and preventing entry of yet other selected substances into the enclosure. The enclosure can be employed to release one or more selected substances into an environment external to the enclosure, to allow entry into the enclosure of one or more selected substances from an environment external to the enclosure, to inhibit and preferably prevent entry of one or more selected substances from the external environment into the enclosure, to retain (inhibit or preferably prevent exit of) one or more selected substances within the enclosure or a combination of these applications. The hole or aperture size or range of sizes in a perforated material of the enclosure can be selected based on the specific application of the enclosure such as meeting or exceeding those mentioned by way of example in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially in relation to the size of substances.

The term enclosure may refer to a space for receiving one or more substances, where the enclosure is formed, at least in part, by a membrane, where, in some embodiments, one or more substances in the enclosure can exit the enclosure by passage through the perforated two-dimensional material. Similarly, in some embodiments, one or more substances from the external environment can enter the enclosure by passage through the membrane. In some embodiments the external environment is a biological environment, which may be an in vivo biological environment or an in vitro biological environment. In some embodiments, the size and/or properties of perforations for each sub-compartment can be the same as and or different from the size and/or properties of perforations in a different sub-compartment.

Enclosures can be in any shape. Thus, the cross-section of an enclosure can be, for example, circular, ovular, rectangular, square, or irregular-shaped. Non-limiting enclosures are described by way of example in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety. The size of the enclosure also is not limited, and can be small enough to circulate in the bloodstream (e.g., on the order of nanometers or larger) or large enough for implantation (e.g., on the order of inches or smaller). In some embodiments, the enclosure is from 100 nm to 6 inches long in its longest dimension, such as from about 100 nm to about 500 nm, about 500 nm to about 1 μm, about 1 μm to about 500 μm, about 500 μm to about 1 mm, about 1 mm to about 50 mm, about 50 mm to about 1 cm, about 1 cm to about 10 cm, about 1 cm to about 20 cm, about 1 cm to about 30 cm, or about 1 cm to about 40 cm.

The thickness of the wall depends, in part, on the membrane used in the wall. Thus, in some embodiments, a wall, or a portion thereof, comprising a membrane is at least 5 nm thick, such as from about 5 nm to about 1 μm thick, from about 5 nm to about 250 nm thick, from about 5 to about 50 nm thick, from about 5 to about 20 nm thick, or from about 20 to about 50 nm thick. In some embodiments, the thickness of the wall is about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm thick, about 25 nm thick, about 30 nm thick, about 35 nm thick, about 40 nm thick, about 45 nm thick, about 50 nm thick, about 100 nm thick, about 150 nm thick, about 200 nm thick, about 250 nm thick, about 300 nm thick, about 400 nm thick, about 500 nm thick, about 600 nm thick, about 700 nm thick, about 800, nm thick, about 900 nm thick, or about 1 μm thick. In some embodiments, the thickness of the wall is up to about 1 μm thick or up to about 1 mm thick. In some embodiments, the thickness of the wall is tailored to allow bidirectional passage of oxygen and nutrients into and out of the enclosure. In some embodiments, the thickness of the wall is tailored to allow entry of oxygen and nutrients into the enclosure at sufficient concentrations to maintain viability of cells within the enclosure, including as described by way of example in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, expecially in relation to entry of oxygen and nutrients.

In some embodiments, the enclosure can be supported by one or more support structures. In some embodiments, the support structure can itself have a porous structure wherein the pores are larger than those of the optional barrier layer (e.g., two-dimensional material). In some embodiments, the support structure is formed as a frame at a perimeter of a two-dimensional material. In some embodiments, the support structure is positioned in part interior to a perimeter of a two-dimensional material. In some embodiments, the substrate layer can convey a desired degree of structural support (e.g., to prevent tearing and/or buckling) to the two-dimensional material layer.

In some embodiments, a substrate layer is positioned on one or both sides or surfaces of the barrier layer. Thus, in some embodiments the substrate layer is positioned on the outside of the enclosure and in some cases is exposed to the external environment (. In some embodiments, the substrate layer is positioned on the inside of the enclosure, and can be separated from an environment external to the enclosure (even though the substrate can be separated from the environment external to the enclosure, it can still be exposed to components from the external environment due to pores in the barrier layer and/or substrate layer). In some embodiments, the substrate layer is positioned on both the outside and the inside of the enclosure. In that case, the substrate layer on the outside of the enclosure can contain materials that are the same as or different from the substrate layer on the inside of the enclosure. In some embodiments, two or more substrate layers are positioned on the same side of the barrier layer (e.g., two or more substrate layers can be positioned on the outside of the enclosure). In some embodiments, the substrate layer is disposed directly on the barrier layer. In some embodiments, the substrate layer is disposed on the barrier layer with high conformance (e.g., by disposing a slightly wet substrate on the barrier layer). In some embodiments, the substrate layer is disclosed with low conformance. In some embodiments, the substrate layer is disposed indirectly on the two-dimensional material; for instance, a porous layer devoid of nanotubes or nanowires can be positioned between the substrate layer and the barrier layer. In some embodiments, the substrate layer is disposed directly or indirectly on another substrate layer. In some embodiments, the barrier layer is suspended on a substrate layer. In some embodiments, the substrate layer is affixed to the barrier layer.

In some embodiments, the substrate layer can increase vascularization near the enclosure, thus prompting the formation of blood vessels and/or tissue ingrowth in close proximity to the enclosure. In some embodiments, the increased vascularization contributes to decreasing the effective distance between the blood stream and substances being eluted from the enclosure. In some embodiments, the increased vascularization contributes to viability of substances enclosed within the enclosure.

In some embodiments, the membrane may comprise a layer comprising a biodegradable polymer. In some embodiments, said layer may form a shell around the enclosure (e.g., it completely engulfs the enclosure). In some embodiments, said shell, or a portion thereof, can be dissolved or degraded, e.g., in vitro. In some embodiments, the shell can be loaded with additives, including additives that protect substances inside the enclosure from air or prevent the need for a stabilizing agent.

In some embodiments, the membrane comprises an intermediate layer disposed between the barrier layer and the substrate layer.

In some embodiments, the enclosure comprises a single compartment that does not contain sub-compartments. In some embodiments, the single compartment is in fluid communication with an external environment separated from the compartment, e.g., by a wall. In some embodiments, the enclosure has a plurality of sub-compartments. In some embodiments, the sub-compartments are in fluid communication with an environment outside the sub-compartment. In some embodiments, each sub-compartment comprises a wall that allows passage of one or more substances into and/or out of the sub-compartment. In some embodiments, the wall or a portion thereof comprises a membrane which allows passage of one or more substances into and/or out of the sub-compartment. In some embodiments, an enclosure is subdivided into two sub-compartments separated from each other at least in part by a membrane, such that the two sub-compartments are in direct fluid communication with each other through pores in the membrane. In some embodiments, the enclosure is subdivided into two sub-compartments each comprising a membrane which sub-compartments are in direct fluid communication with each other through pores in the membrane(s) and only one of the sub-compartments is in direct fluid communication with an environment external to the enclosure. In some embodiments, the enclosure is subdivided into two sub-compartments each comprising a membrane which sub-compartments are in direct fluid communication with each other through pores in the membrane(s) and both of the sub-compartments are also in direct fluid communication with an environment external to the enclosure.

In some embodiments, the compartment comprises two or more sub-compartments. In some embodiments, one or more sub-compartments are separated from an environment external to the sub-compartment. In some embodiments, the one or more sub-compartments are separated from the environment external to the sub-compartment by a wall comprising a perforated graphene-based material.

In some embodiments, the enclosure has an inner sub-compartment and an outer sub-compartment each comprising a membrane, wherein the inner sub-compartment is entirely enclosed within the outer sub-compartment, the inner and outer compartments are in direct fluid communication with each other through pores in the membrane and the inner sub-compartment is not in direct fluid communication with an environment external to the enclosure.

In some embodiments, where an enclosure has a plurality of sub-compartments each comprising a membrane, the sub-compartments are nested one within the other, each of which sub-compartments is in direct fluid communication through pores in the membrane(s) with the sub-compartment(s) to which it is adjacent, the outermost sub-compartment in direct fluid communication with an environment external to the enclosure, the remaining plurality of sub-compartments not in direct fluid communication with an environment external to the enclosure.

In some embodiments, an enclosure includes a substrate layer affixed to multiple sheets of graphene or graphene-based material. In some embodiments, the sheets of graphene or graphene-based materials are stacked upon one another with one of the sheets affixed directly or indirectly to the substrate layer. In some embodiments, one or more sheets of graphene or graphene-based material can be affixed to a first surface of a substrate layer and one or more sheets of graphene or graphene-based material can be affixed to a second surface of the substrate layer. In some embodiments, the graphene-based material is applied to a fully-formed substrate layer, such as a fully-formed electrospun substrate layer. Some embodiments comprise putting multiple layers of the graphene-based material onto the substrate layer (e.g., the fully-formed substrate layer). Without being bound by theory, it is believed that adding multiple layers of graphene-based material onto the substrate layer allows complete coverage of the substrate layer with the graphene-based material.

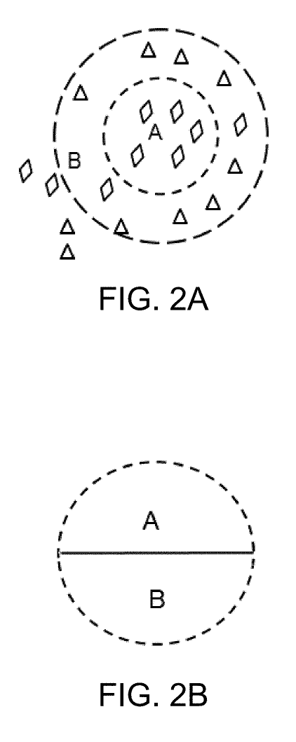

In some embodiments, a sub-compartment can have any shape or size. In some embodiments, 2 or 3 sub-compartments are present. Several examples of enclosure sub-compartments are illustrated in FIGS. 2A-2E. In FIG. 2A, a nested configuration is illustrated, such that sub-compartment B completely contains a smaller sub-compartment A, and substances in the centermost enclosure A can pass into the main enclosure B, and potentially react with or within the main compartment during ingress and egress therefrom. In these embodiments, one or more substances in A can pass into B and one or more substances in A can be retained in A and not enter B. Two sub-compartments in which one or more substances can pass directly between the sub-compartments are said to be in direct fluid communication. Passage between sub-compartments and between the enclosure and the external environment can be via pores of a membrane. In some embodiments, the barrier (e.g., a membrane) between compartment A and B can be permeable to all substances in A or to certain substances in A (i.e., selective permeability). In some embodiments, the barrier between B and the external environment can be permeable to all substances in B or selectively permeable to certain substances in B. In FIG. 2A, sub-compartment A is in direct fluid communication with sub-compartment B which in turn is in direct fluid communication with the external environment. Compartment A in this nested configuration is in indirect fluid communication with the external environment via intermediate passage into sub-compartment B. The membrane employed in different sub-compartments of an enclosure can be the same or different and the pore sizes in the membranes of different sub-compartments can be the same or different.

In FIG. 2B, the enclosure is bisected with an impermeable wall (e.g., formed of non-porous or non-permeable sealant) forming sub-compartments A and B, such that both sections have access to the egress location independently, but there is no direct or indirect passage of substances from A to B. (It will be appreciated, however, that substances exiting A or B can enter the other sub-compartment indirectly via the external environment.)

In FIG. 2C, the main enclosure is again bisected into sub-compartments A and B, but with a membrane forming the barrier between the sub-compartments. Both sub-compartments not only have access to the egress location independently, but also can interact with one another, i.e., the sub-compartments are in direct fluid communication. In some embodiments, the barrier (e.g., a membrane) between sub-compartments A and B is selectively permeable, for example allowing at least one substance in A to pass into B, but not allowing the substances originating in B to pass to A. The porosity of the barrier between sub-compartments (e.g., sub-compartments A and B) can be the same as or different than the porosity of the sub-compartment walls in direct fluid communication with an environment external to the enclosure.

FIG. 2D illustrates an enclosure having three compartments. The enclosure is illustrated with sub-compartment A being in fluid communication with sub-compartment B, which in turn is in fluid communication with sub-compartment C, which in turn is in fluid communication with the external environment. Compartments A and B are not in fluid communication with the external environment, i.e., they are not in direct fluid communication with the external environment. Adjacent sub-compartments A and B and adjacent sub-compartments B and C are each separated by a membrane and are thus in direct fluid communication with each other. Sub-compartment A is only in indirect fluid communication with compartment C and the external environment via sub-compartment B or B and C, respectively. Various other combinations of semi-permeable barrier or non-permeable barriers can be employed to separate sub-compartments. Various pore size constraints can change depending on how the enclosure is ultimately configured. Regardless of the chosen configuration, in some embodiments the boundaries, or at least a portion thereof, of the enclosure can comprise a membrane such that the thickness of the membrane is less than the diameter of the substance to be passed selectively across the two-dimensional material.

FIG. 2E illustrates an enclosure having a single compartment (A) and no sub-compartments. In the figure, the compartment is in direct fluid communication with an environment external to the enclosure.

In some embodiments, the presence of two or more sub-compartments containing the same substance(s) provides redundancy in function so that an enclosure can remain at least partially operable so long as at least one sub-compartment is not compromised.

The multiple physical embodiments for the enclosures and their uses can allow for various levels of interaction and scaled complexity of problems to be solved. For example, a single enclosure can provide drug elution for a given time period, or there can be multiple sizes of pores or perforations to restrict or allow movement of distinct substances, each having a particular size.

Added complexity of the embodiments with multiple sub-compartments can allow for interaction between compounds to catalyze or activate a secondary response (e.g.,, a sense-response paradigm). For example, if there are two sections of an enclosure that function independently, exemplary compound A can undergo a constant diffusion into the body, or either after a given time or in the presence of a stimulus from the body. In some embodiments, exemplary compound A can activate exemplary compound B, or inactivate functionalization that otherwise blocks exemplary compound B from escaping. In some embodiments, binding interactions to produce the foregoing effects can be reversible or irreversible. In some embodiments, exemplary compound A can interact with chemical cascades produced outside the enclosure, and a metabolite subsequent to the interaction can release exemplary compound B (e.g., by inactivating functionalization). The membranes and substrates can be utilized for various enclosures and encapsulation of materials, including such as as described by way of example in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety especially in relation to using source cells (e.g., non-host; allogenic; xenogenic; autogenic; cadeaveric; stem cells, such as fully or partially differentiated stem cells) contained in an enclosure, within which secretions from the cell can produce a sense-response paradigm. In some embodiments, the presence of graphene in the sense-response paradigm does not hinder diffusion, thus allowing a fast time response as compared to enclosures that to not contain graphene.

In some embodiments, growth factors or hormones can be loaded in the enclosure to encourage vascularization, including by way of example as described in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially in relation to vascularization.. In some embodiments, survival of cells within the enclosure can be improved as a result of bi-directional passage of nutrients and waste into and out of the enclosure.

In some embodiments, the relative thinness of graphene can enable bi-directional passage across a wall (or portion thereof) of the enclosure in close proximity to blood vessels, particularly capillary blood vessels, etc.. In some embodiments, using a graphene-based enclosure can provide differentiation over other solutions accomplishing the same effect because the graphene does not appreciably limit permeability; instead, the diffusion of molecules through the graphene apertures can limit the movement of a substance across the wall.

In some embodiments, the perforations allow for zeroth order diffusion through the wall. In some embodiments, osmotic pumps can be used to transport substances across the wall. In some embodiments, natural delta pressures in the body influence passage of substances across the wall. In some embodiments, convective pressure influences passage of substances across the wall. In some embodiments, it is possible to achieve high throughput flux through the wall of the enclosure.

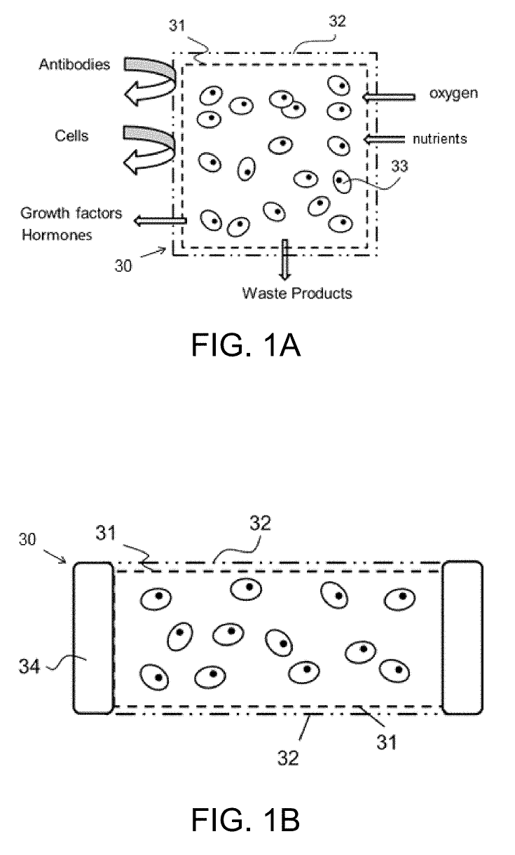

FIGS. 1A and 1B provide a schematic illustration of enclosures with a single compartment though it will be appreciated that the enclosure can having a plurality of sub-compartments, for example, two or three sub-compartments. The enclosure (30) of FIG. 1A is shown as a cross-section formed by an inner sheet or layer (31) comprising the barrier layer (such as, but not limited to, a perforated two-dimensional material, such as a graphene-based material), and an outer sheet or layer (32) comprising a substrate layer (though in some embodiments, the inner layer comprises the substrate layer, and the outer layer comprises the barrier layer). At least a portion of the layer comprising the substrate layer is porous or selectively permeable. The enclosures in FIGS. 1A and 1B contain selected living cells (33) as depicted and alternative could be done with other enclosure configurations such as described in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, especially in relation to their discussion of encapsulating living cells. FIG. 1B provides an alternative cross-section of the enclosure of FIG. 1A, showing the space or cavity formed between a first composite layer (32/31) and a second composite layer (32/31) (in the figure, the cavity is depicted to contain roughly circular symbols, which can be, e.g., cells or any other substance) where a sealant 34 is illustrated as sealing the edges of the composite layers. It will be appreciated that seals at the edges of the composite layers can be formed employing physical methods, such as clamping, crimping, or with adhesives. Methods and materials for forming the seals at the edges are not particularly limiting. In some embodiments, the sealing material provides a non-porous and non-permeable seal or closure. In some embodiments, a portion of the enclosure is formed from a sealant, such as a silicone, epoxy, polyurethane or similar material. In some embodiments, the sealant is biocompatible. For instance, in some embodiments the seal does not span the entire length or width of the device. In some embodiments, the seal forms a complete loop around the cavity. In some embodiments, the seal is formed as a frame at a perimeter of a two-dimensional material. In some embodiments, the seal is positioned, at least in in part, interior to a perimeter of a two-dimensional material.

Some embodiments include methods for using membranes to transport, transfer, deliver, and/or allow passage of substances in or to a biological environment. Some embodiments comprise delivering substances to an environment external to the enclosure (e.g., a biological environment). In some embodiments, the substance positioned on the inside of the enclosure comprises one or more of atoms, molecules, viruses, bacteria, particles and aggregates thereof. For example, the substance can include biological molecules, such as proteins, peptides, nucleic acids, DNA, and/or RNA; pharmaceuticals; drugs; medicaments; therapeutics, including biologics and small molecule drugs; and combinations thereof. The device can house any number of materials subject to encapsulation including by way of example those described in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety.

When the membrane or substrates are utilized with enclosures such as for example described in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, at least a portion of the enclosure can be permeable to oxygen and nutrients sufficient for cell growth and maintenance, to waste produced by the cell (e.g., CO₂), and/or to metabolites produced by the cell (e.g., insulin). In some embodiments, at least a portion of the enclosure is permeable to signaling molecules, such as glucose. In some embodiments, at least a portion of the enclosure is permeable to growth factors produced by cells, such as VEGF.

In some embodiments including other enclosure configurations such as described in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, the membrane and enclosure is not permeable to cells (such as immune cells), viruses, bacteria, antibodies, and/or complements of the immune system. Thus, in some embodiments, cells from the external environment cannot enter the enclosure and cells in the enclosure are retained. In some embodiments, the enclosure is permeable to desirable products, such as growth factors or hormones produced by the cells. The cells within the enclosure can be immunoisolated (i.e., protected from an immune reaction). In some embodiments of enclosures containing cells, the cells are yeast cells, bacterial cells, stem cells, mammalian cells, human cells, porcine cells, or a combination thereof. In some embodiments useful with cells, an enclosure comprises a plurality of sub-compartments, with the cells being positioned within one or more sub-compartments. In some embodiments useful with cells, the enclosure comprises a single compartment. In some embodiments, hole sizes in the barrier layer useful for immunoisolation range in size from 1-50 nm, 1-40 nm, 1-30 nm, 1-25 nm, 1-17 nm, 1-15 nm, 1-12 nm, 1-10 nm, 3-50 nm, 3-30 nm, 3-20 nm, 3-10 nm, or 3-5 nm. In some embodiments, the size of the holes is about 1 nm, about 3 nm about 5 nm, about 10 nm, about 15 nm, about 20 nm, about 30 nm, or about 50 nm. In some embodiments, hole sizes in perforated two-dimensional materials useful for immunoisolation range in size from 1-50 nm, 1-40 nm, 1-30 nm, 1-25 nm, 1-17 nm, 1-15 nm, 1-12 nm, 1-10 nm, 3-50 nm, 3-30 nm, 3-20 nm, 3-10 nm, or 3-5 nm. In some embodiments, the size of the holes is about 1 nm, about 3 nm about 5 nm, about 10 nm, about 15 nm, about 20 nm, about 30 nm, or about 50 nm. In some embodiments, the two-dimensional material is graphene or a graphene-based material.

Some embodiments of the enclosures may comprise perforated graphene comprising pores with a size sufficient to allow a pharmaceutical to pass between the compartment and the external environment. In some embodiments, the perforated graphene-based material has pores with a size of from about 1 nm to about 10 nm. Pore sizes in a wall of one sub-compartment can be the same as or different from pore sizes in a wall of a different sub-compartment.

An enclosure can encapsulate at least one substance. In some embodiments, an enclosure can contain two or more different substances. Different substances can be in the same or in different sub-compartments. In some embodiments, not all of the different substances in the enclosure are released to an environment external to the enclosure. In some embodiments, all of the different substances in the enclosure are released to an external environment. In some embodiments, the rate of release of different substances from the enclosure into an external environment is the same. In some embodiments, the rates of release of different substances from the enclosure into an external environment are different. In some embodiments, the relative amounts of different substances released from the enclosure can be the same or different. The rate of release of substances from the enclosure can be controlled by choice of hole size, hole geometry, hole functionalization or combinations of these.

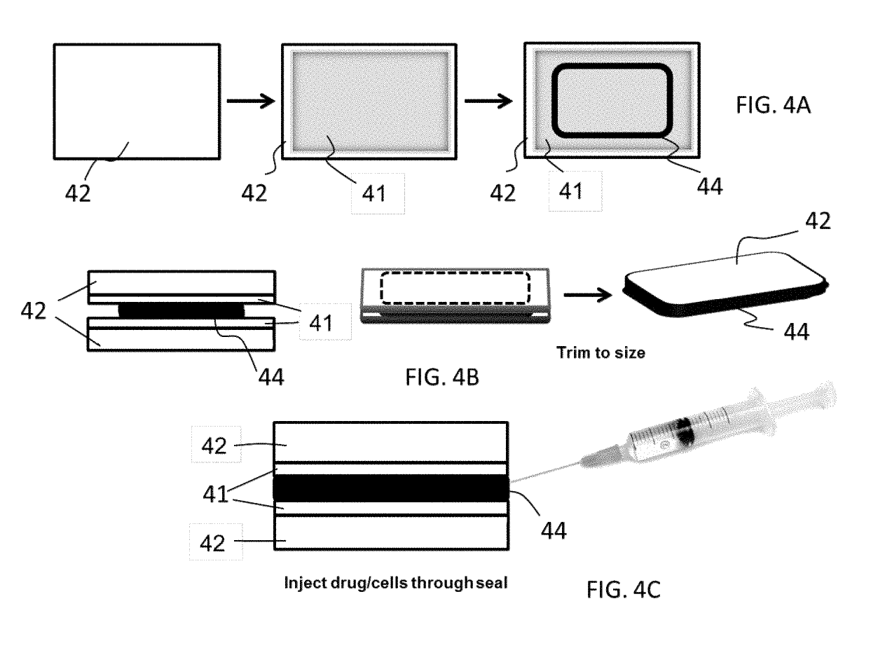

FIGS. 4A-4C illustrate an exemplary method for forming an enclosure and introducing selected substances therein. The method is illustrated with use of a sealant for forming the enclosure. As illustrated in FIG. 4A, a first membrane can be formed by placing a sheet or layer of perforated two-dimensional material, such as a sheet of perforated graphene-based material or a sheet of perforated graphene (41), in contact with a substrate layer (42). At least a portion of the substrate layer (42) of the first membrane can be porous or permeable. Pore size of the substrate layer can be larger than the holes or apertures in the two-dimensional material employed and can be tuned for the environment (e.g., body cavity). A layer of sealant (44), e.g., silicone, is applied on the sheet or layer of perforated two-dimensional material outlining a compartment of the enclosure wherein the sealant will form a non-permeable seal around a perimeter of the enclosure. Formation of a single compartment is illustrated in FIGS. 4A-4C, however, it will be appreciated that multiple independent compartments within an enclosure can be formed by an analogous process. A second membrane formed in the same way as the first is then prepared and positioned with the sheet or layer of perforated two dimensional materials in contact with the sealant. Alternatively, a sealant can be applied to a portion of a membrane and the membrane can be folded over in contact with the sealant to form an enclosure. A seal is then formed within the folded area. Appropriate pressure can be applied to facilitate sealing without damaging the two-dimensional material or its support (e.g., the substrate layer). It will be appreciated that an alternative enclosure can be formed by applying a sheet or layer of non-porous and non-permeable support material in contact with the sealant. In this case only a portion of the enclosure is porous and permeable. Other methods for sealing the enclosure include ultrasonic welding. Sealed layers of membrane are illustrated in FIG. 4B where it is shown that the sealed layers can be trimmed to size around the sealant to form the enclosure. The enclosure formed is shown to have an external porous substrate layer 42 with the sheet or layer of perforated two-dimensional material (41) being positioned as an internal layer, with sealant 44 around the perimeter of the enclosure. Non limiting examples of sealing may include examples described in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety. As illustrated in FIG. 4C, materials that would be excluded from passage through the perforated two-dimensional sheet or layer can be introduced into the enclosure after it is formed by injection through the sealant layer. Any perforation formed by such injection can be sealed as needed.

In some embodiments, substances can be introduced into the enclosure prior to formation of the seal. In some embodiments, one or more ports can be provided for introducing substances into the enclosure. For example, a loading port can be provided within the sealed perimeter of the enclosure, and the loading port can be permanently or semi-permanently sealed after introduction of one or more substances through the loading port. Those in the art will appreciate that sterilization methods appropriate for the application envisioned can be employed during or after the preparation of the enclosure.

In some embodiments, the enclosure encapsulates two or more different substances. In some embodiments, not all of the different substances are released to an environment external to the enclosure. In some embodiments, all of the different substances are released into an environment external to the enclosure. In some embodiments, different substances are released into an environment external to the enclosure at different rates. In some embodiments, different substances are released into an environment external to the enclosure at the same rates.

In some embodiments of any enclosure, at least a portion of the holes or perforations in the two-dimensional material of the enclosure are functionalized.

In some embodiments at least a portion of the two-dimensional material is conductive and a voltage can be applied to at least a portion of the conductive two-dimensional material. The voltage can be an AC or DC voltage. The voltage can be applied from a source external to the enclosure. In some embodiments, an enclosure device further comprises connectors and leads for application of a voltage from an external source to the two-dimensional material.

Additionally, the conductive properties of graphene-based or other two-dimensional materials can allow for electrification to take place from an external source. In exemplary embodiments, an AC or DC voltage can be applied to conductive two-dimensional materials (e.g., in a device such as an enclosure device). The conductivity properties of graphene can provide additional gating to charged molecules or substances. Electrification can occur permanently or only a portion of the time to affect gating. Directional gating of charged molecules can be directed not only through the pores (or restrict travel through pores), but also to the surface of the graphene to adsorb or bind and encourage growth, promote formation of a protective layer, or provide the basis or mechanism for other biochemical effects (e.g., on the body).

In some embodiments, at least once wall, or portion thereof, of the enclosure allows for electrostatic control of charged species, for instance in nanofluidic or microfluidic systems. In some embodiments, the wall allows for control of charged species by varying the applied voltage, for instance in nanofluidic or microfluidic systems. In some embodiments, the wall can be tuned to manipulate ion passage at low and/or high ion concentrations. In some embodiments, the wall is an ion-selective membrane. In some embodiments, the wall comprises one or more voltage-gated ion channels, such as voltage-gated pores. In some embodiments, the wall mimics biological voltage-gated ion channels. In some embodiments, the wall is a solid-state membrane. In some embodiments, nanochannel or nanopore transistors can be used to manipulate ion passage.

In some embodiments, the wall can be tuned using low or high applied voltages. In some embodiments, the wall allows high ionic flux. In some embodiments, the wall allows low ion flux. In some embodiments, pores in the wall modulates current of ions at low gate voltages and/or display high selectivity. In some embodiments, ion flux across the wall can be turned on or off at low applied voltages, such as ≤500 mV. In some embodiments, ion flux across the wall can be turned on or off at biologically relevant ion concentrations, such as up to 1 M. In some embodiments, the applied voltage can modulate on species selectivity, e.g., cation or anion selectivity.

In some embodiments, nanopores can be electrostatically controlled at low voltages and biologically relevant ion concentrations. In some embodiments, walls are used in separation and sensing technologies. In some embodiments, walls are used in water filtration, water desalination, water purification, osmosis, energy storage, microfluidic devices, nanofluidic devices, and/or therapeutic methods. In some embodiments, walls are used in immune-isolation (i.e., protecting substances from an immune reaction), timed drug release (e.g., sustained or delayed release), hemodialysis, and hemofiltration. Some embodiments relate to methods for separating ions or other substances; methods for sensing ions; methods for storing energy; methods for filtering water; and/or methods of treating a disease or condition (e.g., diabetes). Some embodiments relate to methods of ultrafiltration, nanofiltration and/or microfiltration. Some embodiments comprise using gating to control release of substances. Some embodiments comprise using gating to allow for different substances to be released at different times. Some embodiments comprise allowing different substances to pass through the wall at different times, thus modulating when and how substances mix and interact with other substances in a specific order.

Some embodiments comprise a method comprising introducing an enclosure comprising perforated two-dimensional material into an environment, the enclosure containing at least one substance; and releasing at least a portion of the at least one substance through the holes of the two-dimensional material to the environment external to the enclosure. In some embodiments, the enclosure contains cells which are not released from the enclosure and the at least one substance, a portion of which is released, is a substance generated by the cells in the enclosure including variations described as for example in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety.

Some embodiments comprise a method comprising introducing an enclosure comprising perforated two-dimensional material to an environment, the enclosure containing at least one first substance; and allowing migration of other substances from the environment into the enclosure. In some embodiments, the other substances include nutrients and/or oxygen.

Both permanent and temporary binding of substances to the enclosure are possible. In some embodiments, enclosures represent a disruptive technology for state of the art vehicle and other devices, such that these vehicles and devices to be used in new ways. For example, cell line developments, therapeutic releasing agents, and sensing paradigms (e.g., MRSw's, NMR-based magnetic relaxation switches, see; Koh et al. (2008) Ang. Chem. Int'l Ed. Engl., 47(22) 4119-4121) can be used. Moreover, some embodiments mitigate biofouling and bioreactivity, convey superior permeability and less delay in response, and provide mechanical stability.

In some embodiments, enclosures can be used in non-therapeutic applications, such as in dosing probiotics in dairy products.

Some embodiments comprise enclosures comprising a compartment and a wall separating the compartment from an environment external to the compartment, wherein the wall comprises a membrane comprising a perforated graphene-based material layer and a substrate layer, and wherein the substrate layer comprises a plurality of substrate pores, and each of the substrate pores comprises a plurality of nanotubes or nanowires positioned within the substrate pore. In some embodiments, an enclosure may comprise a compartment and a wall separating the compartment from an environment external to the compartment, wherein the wall comprises a membrane comprising a perforated graphene-based material layer and a substrate layer, and wherein the substrate layer comprises a plurality of substrate pores, and each of the substrate pores comprises a plurality of carbon nanotubes or carbon nanowires positioned within the substrate pore. In some embodiments, the substrate layer is affixed directly to perforated graphene-based material. In some embodiments, the substrate layer is affixed indirectly to the perforated graphene-based material. In some embodiments, the substrate layer comprises track-etched polyimide. In some embodiments, the compartment is in fluid communication with the external environment. In some embodiments, at least a portion of the wall is from about 5 nm to about 1 μm thick. Some embodiments further comprise at least one substance encapsulated within the compartment. Some embodiments comprise two or more substances are encapsulated within the compartment. In some embodiments, the membrane has pores with a size sufficient to retain the substance within the compartment and to exclude immune cells and immune complexes in the environment external to the compartment from entering the compartment. In some embodiments, the substances are yeast or bacteria.

In some embodiments, an enclosure comprises one or more than one sub-compartments each sub-compartment comprising a membrane such that at least a portion of the walls or sides forming the sub-compartment comprise the membrane. Fluid communication is achieved by selective passage of one or more substances in and/or out of the enclosure or sub-compartment. Thus, compartments and sub-compartments separated from an external environment can be in fluid communication with the external environment. The fluid can be liquid or gas and includes fluids having entrained gases. Substances can be dissolved or suspended or otherwise carried in a fluid. The fluid can be aqueous. A sub-compartment can be in direct fluid communication with adjacent sub-compartments and/or the external environment (where adjacent sub-compartments share at least one wall or side). In some embodiments one or more sub-compartments can be in direct fluid communication with adjacent sub-compartments, but not in direct fluid communication with the external environment. At least one sub-compartment in an enclosure is in direct fluid communication with an external environment. An enclosure can have various configurations of sub-compartments. A sub-compartment can have any shape. A sub-compartment may, for example, be spherical, cylindrical or rectilinear. In some embodiments, sub-compartments can be nested. In some embodiments, the enclosure can have a central sub-compartment which shares a wall or side with a plurality of surrounding sub-compartments. In some embodiments, sub-compartments can be linearly aligned within the enclosure. In some embodiments, an enclosure contains two sub-compartments. In some embodiments, an enclosure contains three, four, five or six sub-compartments. In some embodiments, a sub-compartment can be fully contained within another sub-compartment, wherein the inner sub-compartment is in direct fluid communication with the outer sub-compartment and the outer-sub-compartment is in direct fluid communication with the external environment. In these embodiments, the inner sub-compartment is in indirect rather than direct fluid communication with the external environment. In some embodiments where an enclosure contains a plurality of sub-compartments or is divided into a plurality of sub-compartments, at least one sub-compartment is in direct fluid communication with the external environment and remaining sub-compartments are in direct fluid communication with adjacent sub-compartments, but may not all be in direct fluid communication with the external environment. In some embodiments where an enclosure contains a plurality of sub-compartments, all sub-compartments can be in direct fluid communication with the external environment.

Some embodiments comprise enclosures comprising a compartment and a wall separating the compartment from an environment external to the compartment, wherein the wall comprises a membrane, and the membrane enhances integration of the enclosure into tissue and/or vascularization to the enclosure.

In some embodiments, an enclosure comprises a membrane forming at least one wall of the enclosure, wherein the enclosure is separated from an environment external to the enclosure. In some embodiments, the enclosure comprises two or more sub-compartments. In some embodiments, an enclosure or sub-compartment is substantially sealed from an environment external to the enclosure or sub-compartment when passage of substances into or out of the enclosure or sub-compartment occurs almost exclusively (i.e., at least 95%) through pores and/or perforations in the membrane. In particular, edges of the membrane are substantially sealed when passage of substances into or out of the enclosure or sub-compartment occurs almost exclusively (i.e., at least 95%) through pores and/or perforations in the membrane. Degree of sealing can be calculated, for instance, based on an integrity test using a control enclosure produced with or without pores and/or perforations.

At least one substance can be encapsulated within the enclosure, such that the at least one substance is released to an environment external to the enclosure by passage through pores and/or perforations in the membrane. In some embodiments, at least once substance within the enclosure produces a second substance that can be released to an environment external to the enclosure by passage through pores and/or perforations in the membrane. In some embodiments, two or more different substances are encapsulated within the enclosure. In some embodiments, the substance within the enclosure that is released to an environment external to the enclosure through pores and/or perforations in the membrane can be a pharmaceutical. In some embodiments including by way of example applications of the membrane to enclosures described in U.S. Pat. No. 5,344,454, US 2010/0196439, US 2010/0124564, and Lathuiliere et al., “Encapsulated Cellular Implants for Recombinant Protein Delivery and Therapeutic Modulation of the Immune System”, Int. J. Mol. Sci. 2015, each incorporated herein by reference in their entirety, the substance within the enclosure is cells and the size of the pores and/or perforations in the membrane is selected to retain the cells within the enclosure and to possibly exclude immune cells and immune complexes from entering the enclosure from the environment external to the enclosure. In some embodiments, the substance within the enclosure is cells and the size of the pores and/or perforations in the membrane is selected to retain the cells within the enclosure while immune cells and immune complexes from the environment external to the enclosure can enter the enclosure. For example, the cells can be stem cells, yeast cells, bacterial cells, or mammalian cells.

Some embodiments comprise coated therapeutic devices comprising: (i) a therapeutic device and (ii) a coating on the therapeutic device, wherein the coating comprises a membrane. In some embodiments, the coated therapeutic device delays or does not provoke an immune response from an environment to which the device is exposed. In some embodiments, the coated therapeutic device delays or does not provoke an immune response from a subject when the device is in use within the subject.

In some embodiments, the device comprises a sensor. A non-limiting example of a sensor is a glucose sensor. In some embodiments, the sensor may be a solid-state sensor. In some embodiments, the device comprises a sensor which controls the release of material stored within the device. In some embodiments, the device comprises a sensor which controls the capture of a substance to be released at a later time.

Methods of Use or Methods of Preparation

Some embodiments comprise methods of releasing a substance comprising exposing an enclosure comprising a wall comprising a membrane to an environment, to thereby release into the environment at least one substance from a compartment in the enclosure. In some embodiments, the environment is a biological environment. In some embodiments, the substance is a pharmaceutical. Some embodiments comprise exposing an enclosure comprising a membrane to an environment, to thereby release at least one first substance into the environment and to allow passage of a second substance from the environment into the enclosure. In some embodiments, the second substance is a nutrient or oxygen. In some embodiments, a substance that enters the enclosure can return to the environment.

Some embodiments comprise methods of preparing an enclosure, wherein the enclosure comprises a compartment and a wall separating the compartment from an environment external to the compartment, wherein the wall comprises a membrane. In some embodiments, the substrate layer comprises track-etched polyimide, track-etched polycarbonate, track-etched PET, or a combination of any two or more thereof. In some embodiments, the substrate layer comprises track-etched polyimide. In some embodiments, the substrate layer comprises track-etched polycarbonate. In some embodiments, the substrate layer comprises track-etched PET.

Some embodiments comprise methods of preparing a substrate layer, wherein the a layer of polymer (e.g., polyimide, polycarbonate, PET, or a combination of any two or more thereof) is infused with nanotubes or nanowires to form an infused polymer layer; and the infused polymer layer is tracked (e.g., irradiated with heavy ions) and then etched using methods known to one skilled in the art. Some embodiments comprise methods of preparing a substrate layer, wherein the a layer of polymer (e.g., polyimide, polycarbonate, PET, or a combination of any two or more thereof) is infused with nanotubes or nanowires to form an infused polymer layer; and the infused polymer layer is laser drilled. Some embodiments comprise methods of preparing a substrate layer, wherein the a layer of polymer (e.g., polyimide, polycarbonate, PET, or a combination of any two or more thereof) is infused with nanotubes or nanowires to form an infused polymer layer; and the infused polymer layer is lithographically patterned and then etched using methods known to one skilled in the art.

Some embodiments comprise methods of improving biocompatibility of an enclosure, wherein the method comprises forming an enclosure with a membrane described herein.

Methods for transporting and delivering substances in a biological environment are also described. In some embodiments, the methods can include introducing an enclosure comprising a membrane, and releasing at least a portion of a substance in the enclosure to the biological environment. In some embodiments, methods can include introducing an enclosure comprising a membrane into a biological environment, and allowing migration of a substance from the biological environment into the enclosure.

Some embodiments comprise a method comprising: introducing an enclosure comprising a membrane to an environment, the enclosure containing at least one substance; and releasing at least a portion of the at least one substance through the pores and/or perforations in the membrane to the environment external to the enclosure. In some embodiments, the environment is a biological environment. In some embodiments, the at least one substance, a portion of which is released, is a drug. In some embodiments, the enclosure contains substances which are not released from the enclosure and the at least one other substance, a portion of which is released, is a substance generated in the enclosure. Any enclosure can be employed in this method.

In some embodiments, the method comprises: introducing an enclosure comprising a membrane to a environment, the enclosure containing at least one first substance; and allowing migration of a second substance from the environment into the enclosure. Any enclosure can be employed in this method.

In some embodiments, the second substance is a nutrient or oxygen.

In some embodiments, upon reaction or complexation of the first substance within the enclosure with the second substance that enters the enclosure, the second substance is substantially trapped inside the enclosure and inhibited from returning to the environment external to the enclosure. For example, a chemical complex of the first and second substance can be larger than the average pore size of the membrane such that less than 10%, less than 5%, less than 2% or less than 1% of the second substance returns to the environment external to the enclosure.

In some embodiments, the method comprises: introducing an enclosure comprising a membrane to an environment, the enclosure containing at least one substance; and releasing at least a portion of the at least one substance through the holes of the membrane to the environment external to the enclosure. Any enclosure can be employed in this method.

In some embodiments, the method comprises: introducing an enclosure comprising a membrane described to an environment, the enclosure containing at least one first substance; and allowing migration of a second substance from the environment into the enclosure. In some embodiments, the second substance is nutrients and another second substance is oxygen. Any enclosure can be employed in this method.

Some embodiments comprise methods of releasing a substance into an environment from an enclosure that delays or does not provoke an immune response from the environment. Some embodiments comprise treating a condition or disease in a subject by administering into the subject an enclosure that delays or does not provoke an immune response from the subject. Some embodiments comprise using the enclosure in methods of immunoisolation (i.e., protecting substances from an immune reaction), timed drug release (e.g., sustained or delayed release), hemodialysis, or hemofiltration.

Some embodiments comprise encapsulating a device with a membrane. In some embodiments, the encapsulated device delays or does not provoke an immune response from the environment to which the device is exposed. In some embodiments, the encapsulated device delays or does not provoke an immune response from a subject when the device is in use within the subject.

Some embodiments comprise methods of coating a therapeutic device with a membrane. In some embodiments, the membrane is applied to the exterior of the therapeutic device. Some embodiments comprise the coated therapeutic device. In some embodiments, the coated therapeutic device delays or does not provoke an immune response from the environment to which the device is exposed.

Without being bound by theory, it is believed that the biocompatibility of graphene can further promote capillary vascularization into the substrate layer, particularly by functionalizing the graphene to improve compatibility with a particular biological environment (e.g., via available edge bonds, bulk surface functionalization, pi-bonding, and the like). Functionalization can provide enclosures having added complexity for use in treating local and systemic disease.

In some embodiments, enclosures can be further modified to incorporate any number of variations, alterations, substitutions or equivalent arrangements not heretofore described, but which are commensurate with the spirit and scope of the disclosure. Accordingly, the enclosures and methods are not limited by the foregoing description.

Specific names of compounds are intended to be exemplary, as it is known that one of ordinary skill in the art can name the same compounds differently. When a compound is described such that a particular isomer or enantiomer of the compound is not specified, for example, in a formula or in a chemical name, that description is intended to include each isomer and enantiomer of the compound described individually or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention. Whenever a range is given in the specification, for example, a temperature range, a time range, or a composition range, all intermediate ranges and subranges, as well as all individual values included in the ranges given are intended to be included in the disclosure. When a Markush group or other grouping is used, all individual members of the group and all combinations and subcombinations possible of the group are intended to be individually included in the disclosure.

About will be understood by persons of ordinary skill in the art and will vary to some extent depending upon the context in which it is used. If there are uses of the term which are not clear to persons of ordinary skill in the art, given the context in which it is used, about will mean up to plus or minus 10% of the particular term.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although some embodiments have been specifically disclosed, modification and variation of the concepts may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claims.

### EXAMPLES

Some embodiments are further illustrated by the following examples. The examples are provided for illustrative purposes only, and are not to be construed as limiting the scope or content of embodiments any way.

### Example 1. Non-Limiting Exemplary Procedure for Patterning a Substrate Layer

The general procedures for patterning a polyimide (PI) film can be divided into several major steps: prepare the wafer for better adhesion, apply base PI film (this step is for better release of the patterned film to form a stand-alone film), and create a patterned PI film.

Wafer preparation: A silicon wafer is placed into a spin coater, and the wafer surface is coated with adhesion promoter. The solution is allowed to sit on the wafer surface for about 20 seconds. The coated silicon wafer is spun dried at 2000-3000 RPM for about 30 seconds. Optionally, the coated silicon wafer is baked at 110-130° C. for 15 min in an oven.

Base PI film formation: The coated silicon wafer is placed into a spin coater. The wafer surface is coated with PI precursor, the coating is spread by spinning at 500 RPM for about 5 seconds. Depending on the cured film thickness required, spin speeds are adjusted. If needed, a backside rinse and/or edge-bead removal is performed with N-methyl-pyrrolidinone (NMP) or cyclopentanone. A soft bake is performed on the wafer, with typical temperatures of 130-200° C. for 30-40 min (convection oven). After the soft bake, a full cure is required. In a convection oven, ramp rate may be controlled to be about 2-4° C./min under inert atmosphere. In some embodiments, 350° C. under inert atmosphere for 30 min is sufficient. Under ambient conditions, 300° C. for 30-45 min may be sufficient. Time and temperature dictate the degree of cure. The degree of cure may vary depending on desired properties.

Formation of patterned PI film: Silver nanowire is mixed with base polymer (e.g., polyimide). The mixture may be subjected to mechanical stirring, blending, shear mixing and/or sonication to create a uniformly dispersed mixture. The silicon wafer coated with the base PI film is flooded with a coating of the uniformly dispersed mixture at static conditions, such that the mixture is allowed to flow on the surface. Depending on the desired cured film thickness, an appropriate spin speed (30 seconds) is selected. 1200-400 RPM corresponds to 7-20 micron final film thickness. A prebake is conducted. In some embodiments using a hot plate, the prebake conditions of 90° C. for 120 seconds is followed by 110° C. for 120 seconds. Use of a convection oven may lead to longer prebake times. After prebake, the silicon wafer is subjected to exposure to a desired light source of 200-500 mJ/cm². An optional post-exposure bake (e.g., 110° C. for ˜120 seconds with a hot plate; convection oven times would be longer) may be completed. The sample is allowed to cool back to room temperature when such a post-exposure bake is conducted. Development can occur with 2×30 second steps with puddles and a 50 second spray. Once developer is utilized, a rinse is necessary. Rinsing can be performed under various conditions, e.g., 2×30 second steps with puddles and a 50 second spray or 7 seconds at 1000 RPM under spray or shower. After rinsing, the silicon wafer undergoes a final curing step (e.g., 350-390° C. for 60 min in an oven under inert (e.g., nitrogen or argon) atmosphere) before being cooled to room temperature prior to handling. Removal of the patterned PI film from the silicon wafer base is performed by creating a shallow channel long the perimeter of the removal area. The channel may be created by laser etching or mechanical scribing. One edge of the layer may be lifted up by either attaching an adhesive tape or by use of a razor blade. Gentle lifting separates the patterned PI film from the wafer base.

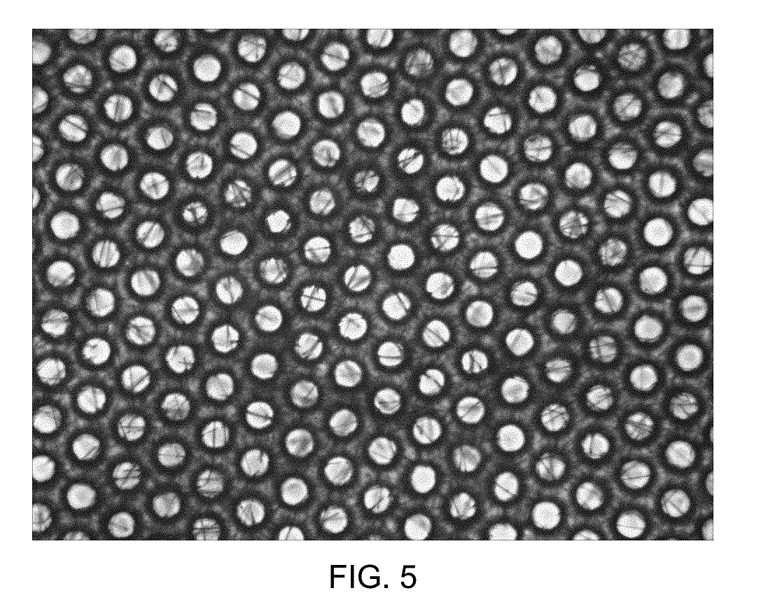

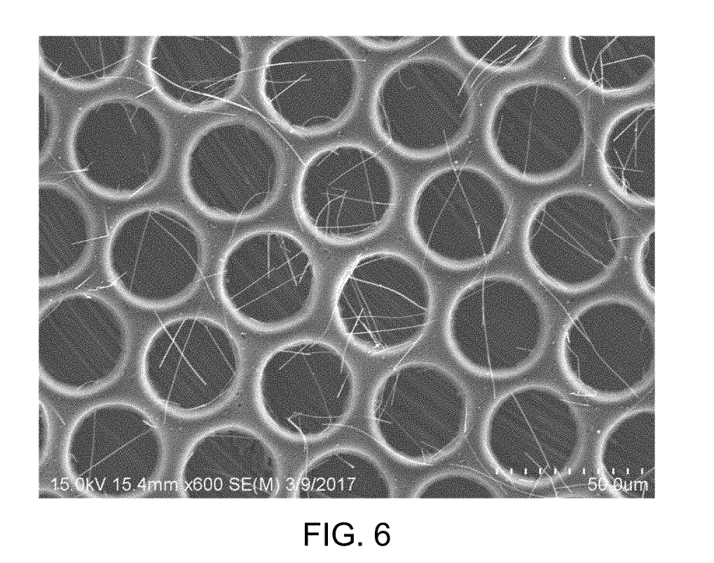

FIGS. 5 and 6 illustrate micrographs of two separate PI films obtained by the process described in Example 1. In FIG. 5, silver nanowires are embedded in the PI film and span the pores. The nanowires do not wholly exclude transport through the pores. In FIG. 6, silver nanowires are embedded in the PI film, but with a lower density of silver nanowires compared to the embodiment shown in FIG. 5. The surface over which the PI film is mounted for viewing is visible in the SEM micrograph of FIG. 6.

### Example 2. Non-Limiting Exemplary Procedure for Patterning a Substrate Layer

Wafer preparation and base film preparation are conducted as described for Example 1, replacing polyimide with polycarbonate. Formation of a patterned composite polycarbonate film containing carbon nanotubes is performed as follows. An initial film is prepared by compounding and direct extrusion or by spin coating a polycarbonate/carbon nanotube NMP mixture as analogously described in Example 1. The composite film is subjected to heavy ion beam irradiation. During the irradiation, when the high velocity ion passes through the film, the ion breaks chemical bonds in the polymer along its path to create an invisible track. The polymer film is subsequently gradually etched by exposure to a mild etchant such as potassium hydroxide. Since the polymer is weaker along the tracks created by the irradiation, preferential etching along the tracks occurs, creating a porous film with straight pores. Since the carbon nanotube is more chemically stable than the polymer, the carbon nanotubes remain intact in the pores, thereby generating the desired morphology.

### Example 3. Non-Limiting Exemplary Procedure for Patterning a Substrate Layer

An additional step is added to the process described in Example 2 to further selectively remove additional polymer and potentially improve the overall permeability of the substrate layer. This additional step involves the application of a patterned Excimer laser bean to the surface of the patterned composite film. The laser beam is designed so that only some of the polymer is removed but no additional pores are created. A subsequent rinse in water with cleaning agent or alcohol is conducted to remove residue from the pores.

What is claimed is the following:

1. A membrane comprising
(i) at least one substrate layer and
(ii) at least one porous layer devoid of carbon nanotubes or carbon nanowires,
wherein
each substrate layer comprises a plurality of substrate pores, and each of the substrate pores comprises a plurality of carbon nanotubes or carbon nanowires positioned within the substrate pore; and wherein
each substrate layer and each porous layer comprises a material independently selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof.

2. The membrane of claim 1, wherein each substrate layer has a thickness of about 1 mm or less.

3. The membrane of claim 1, wherein each of the substrate pores in each substrate layer has a diameter of about 500 μm or less.

4. The membrane of claim 1, wherein each of the carbon nanotubes or carbon nanowires has a diameter of about 150 nm or less.

5. The membrane of claim 1, wherein carbon nanotubes or carbon nanowires are dispersed within each substrate layer.

6. The membrane of claim 5, wherein the substrate layer comprises 5 wt. % or less of the carbon nanotubes or carbon nanowires.

7. A membrane comprising at least one substrate layer, wherein each substrate layer comprises a plurality of substrate pores, each of the substrate pores comprises a plurality of nanotubes or nanowires positioned within the substrate pore, and the substrate layer comprises a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof.

8. The membrane of claim 7, wherein each substrate layer has a thickness of about 1 mm or less.

9. The membrane of claim 7, wherein each of the substrate pores has a diameter of about 500 μm or less.

10. The membrane of claim 7, wherein each of the nanotubes or nanowires has a diameter of about 500 nm or less.

11. The membrane of claim 7, wherein the nanotubes or nanowires are dispersed within the substrate layer.

12. The membrane of claim 11, wherein at least one substrate layer comprises 5 wt. % or less of the nanotubes or nanowires.

13. The membrane of claim 7, wherein the membrane comprises two or more substrate layers and a weight percentage of nanotubes or nanowires is not the same for all of the substrate layers.

14. The membrane of claim 7, wherein the nanotubes or nanowires are carbon nanotubes or carbon nanowires.

15. The membrane of claim 7, wherein the nanotubes or nanowires comprise elemental metal.

16. The membrane of claim 7, wherein the nanotubes or nanowires comprise gold, silver, platinum, palladium, chromium, copper, titanium, stainless steel, vanadium oxide, or any combination of two or more thereof.

17. The membrane of claim 7, wherein the membrane comprises two or more substrate layers and the nanotubes or nanowires within each substrate layer do not comprise the same material.

18. A membrane comprising a perforated graphene-based material layer and a substrate layer, wherein the substrate layer comprises a plurality of substrate pores, and each of the substrate pores comprises a plurality of nanotubes or nanowires positioned within the substrate pore.

19. The membrane of claim 18, wherein the substrate layer comprises a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof.

20. The membrane of claim 18, wherein the substrate layer has a thickness of about 1 mm or less.

21. The membrane of claim 18, wherein each of the substrate pores has a diameter of about 500 μm or less.

22. The membrane of claim 18, wherein each of the nanotubes or nanowires has a diameter of about 500 nm or less.

23. The membrane of claim 18, wherein the nanotubes or nanowires are dispersed within the substrate layer.

24. The membrane of claim 23, wherein the substrate layer comprises 5 wt. % or less of the nanotubes or nanowires.

25. The membrane of claim 18, wherein the nanotubes or nanowires are carbon nanotubes or carbon nanowires.

26. The membrane of claim 18, wherein the nanotubes or nanowires comprise elemental metal.

27. The membrane of claim 18, wherein the nanotubes or nanowires comprise gold, silver, platinum, palladium, chromium, copper, titanium, stainless steel, vanadium oxide, or any combination of two or more thereof.

28. The membrane of claim 18, wherein the perforated graphene-based material layer has pores with a diameter of from about 1 nm to about 10 nm.

29. The membrane of claim 18, wherein the graphene-based material is graphene.

30. The membrane of claim 29, wherein the perforated graphene-based material layer comprises at least one perforated graphene layer.

31. The membrane of claim 18, further comprising an intermediate layer positioned between the perforated graphene-based material layer and the substrate layer.

32. A membrane comprising
(i) at least one substrate layer;
(ii) at least one porous layer devoid of nanotubes or nanowires; and
(iii) a barrier layer;
wherein
each substrate layer comprises a plurality of substrate pores, and each of the substrate pores comprises a plurality of nanotubes or nanowires positioned within the substrate pore; and wherein
each substrate layer and each porous layer comprises a material independently selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof.

33. The membrane of claim 32, wherein each substrate layer has a thickness of about 1 mm or less.

34. The membrane of claim 32, wherein each of the substrate pores in each substrate layer has a diameter of about 500 μm or less.

35. The membrane of claim 32, wherein each of the nanotubes or nanowires has a diameter of about 500 nm or less.

36. The membrane of claim 32, wherein the nanotubes or nanowires are dispersed within each substrate layer.

37. The membrane of claim 36, wherein at least one substrate layer comprises 5 wt. % or less of the nanotubes or nanowires.

38. The membrane of claim 32, wherein the membrane comprises two or more substrate layers and a weight percentage of nanotubes or nanowires is not the same for all of the substrate layers.

39. The membrane of claim 32, wherein the nanotubes or nanowires are carbon nanotubes or carbon nanowires.

40. The membrane of claim 32, wherein the nanotubes or nanowires comprise elemental metal.

41. The membrane of claim 32, wherein the nanotubes or nanowires comprise gold, silver, platinum, palladium, chromium, copper, titanium, stainless steel, vanadium oxide, or any combination of two or more thereof.

42. The membrane of claim 32, wherein the membrane comprises two or more substrate layers and the nanotubes or nanowires within each substrate layer do not comprise the same material.

43. The membrane of claim 32, wherein the barrier layer comprises a perforated graphene-based material layer.

44. The membrane of claim 43, wherein the perforated graphene-based material layer has pores with a diameter of from about 1 nm to about 10 nm.

45. The membrane of claim 43, wherein the graphene-based material is graphene.

46. The membrane of claim 45, wherein the perforated graphene-based material layer comprises at least one perforated graphene layer.

47. The membrane of claim 32, further comprising an intermediate layer positioned between the barrier layer and at least one substrate layer.

48. A membrane comprising at least one substrate layer, wherein the substrate layer comprises a plurality of substrate pores, and each of the substrate pores comprises a plurality of nanotubes or nanowires positioned within the substrate pore.

49. The membrane of claim 48, wherein each substrate layer comprises a material selected from the group consisting of polysulfones, polyurethane, polymethylmethacrylate (PMMA), polyglycolid acid (PGA), polylactic acid (PLA), polyethylene glycol (PEG), polylactic-co-glycolic acid (PLGA), polyamides, polyimides, polypropylene, polyethersulfones (PES), polyvinylidine fluoride (PVDF), cellulose acetate, polyethylene, polyethylene terephthalate (PET), polypropylene, polycarbonate, polytetrafluoroethylene (PTFE), polyvinylchloride (PVC), polyether ether ketone (PEEK), polycaprolactone, polydimethylsiloxane (PDMS), block co-polymers of any of these, and combinations and/or mixtures thereof.

50. The membrane of claim 48 wherein each substrate layer has a thickness of about 1 mm or less.

51. The membrane of claim 50, wherein each substrate layer has a thickness of about 100 nm to about 1 mm.

52. The membrane of claim 51, wherein each substrate layer has a thickness of about 1 μm to about 25 μm.

53. The membrane of claim 48, wherein each substrate layer has a porosity gradient throughout its thickness.

54. The membrane of claim 48, wherein each of the substrate pores has a diameter of about 500 μm or less.

55. The membrane of claim 54, wherein each of the substrate pores has a diameter of about 30 nm to about 500 μm.

56. The membrane of claim 55, wherein each of the substrate pores has a diameter of about 500 nm to about 100 μm.

57. The membrane of claim 48, wherein each of the nanotubes or nanowires has a diameter of about 500 nm or less.

58. The membrane of claim 57, wherein each of the nanotubes or nanowires has a diameter of about 1 nm to about 150 nm.

59. The membrane of claim 58, wherein each of the nanotubes or nanowires has a diameter of about 5 nm to about 150 nm.

60. The membrane of claim 48, wherein the nanotubes or nanowires are dispersed within the substrate layer.

61. The membrane of claim 60, wherein at least one substrate layer comprises 5 wt. % or less of the nanotubes or nanowires.

62. The membrane of claim 48, wherein the membrane comprises one substrate layer.

63. The membrane of claim 48, wherein the membrane comprises two or more substrate layers and a weight percentage of nanotubes or nanowires is not the same for all of the substrate layers.

64. The membrane of claim 48, wherein the membrane comprises two or more substrate layers and the nanotubes or nanowires within each substrate layer do not comprise the same material.

65. The membrane of claim 48, wherein the nanotubes or nanowires are carbon nanotubes or carbon nanowires.

66. The membrane of claim 48, wherein the nanotubes or nanowires comprise elemental metal.

67. The membrane of claim 48, wherein the nanotubes or nanowires comprise gold, silver, platinum, palladium, chromium, copper, titanium, stainless steel, vanadium oxide, or any combination of two or more thereof.

68. The membrane of claim 48, further comprising a barrier layer.

69. The membrane of claim 68, wherein the barrier layer comprises a perforated graphene-based material layer.

70. The membrane of claim 69, wherein the perforated graphene-based material layer has pores with a size sufficient to allow a pharmaceutical to pass through the pores.

71. The membrane of claim 70, wherein the perforated graphene-based material layer has pores with a diameter of from about 1 nm to about 10 nm.

72. The membrane of claim 69, wherein the graphene-based material is graphene.

73. The membrane of claim 72, wherein the perforated graphene-based material layer comprises at least one perforated graphene layer.

74. The membrane of claim 48, further comprising at least one porous layer devoid of nanotubes or nanowires.

75. The membrane of claim 74, wherein the membrane comprises alternating layers of the substrate layer and of the porous layer devoid of nanotubes or nanowires.

76. The membrane of claim 68, wherein the barrier layer is positioned as an outermost layer of the membrane.

77. The membrane of claim 68, wherein one substrate layer is directly disposed on the barrier layer.

78. The membrane of claim 68, wherein one substrate layer is indirectly disposed on the barrier layer.

79. The membrane of claim 48, further comprising an intermediate layer positioned between the barrier layer and one substrate layer.
